(19) United States
(12) Patent Application Publication
(10) Pub. No.: US 2022/0070881 A1
(43) Pub. Date: Mar. 3, 2022

(54) METHOD AND DEVICE FOR WIRELESS COMMUNICATION

(71) Applicant: NTT DOCOMO, INC., Tokyo (JP)

(72) Inventors: Huan Wang, Haidian District, Beijing (CN); Xiaolin Hou, Haidian District, Beijing (CN); Jing Wang, Haidian District, Beijing (CN); Shohei Yoshioka, Chiyoda-ku, Tokyo (JP)

(73) Assignee: NTT DOCOMO, INC., Tokyo (JP)

(21) Appl. No.: 17/415,357

(22) PCT Filed: Jan. 4, 2019
(86) PCT No.: PCT/CN2019/070489

§ 371 Date: Jun. 17, 2021

(51) Int. Cl. H04W 72/12; H04W 72/02; H04W 72/08; H04W 8/00

(52) U.S. Cl. CPC H04W 72/121; H04W 8/005; H04W 72/085; H04W 72/02

(57) ABSTRACT

The present disclosure provides a method and device for wireless communication, where the device may be a first-type user terminal, and the method performed by the device includes: acquiring detection information for another first-type user terminal, where the first-type user terminal is used to control a second-type user terminal, and the first-type user terminal and the second-type user terminal belong to one user terminal group; determining, according whether to regroup the user terminal group at least according to the acquired detection information; and regrouping the user terminal group when it is determined to regroup the user terminal group.

### TECHNICAL FIELD

The present disclosure relates to a field of wireless communication, and in particular, to a method and a device for wireless communication.

### BACKGROUND

In order to improve spectrum efficiency of a communication system, a Device-to-Device (D2D) communication technology has been proposed. In D2D communication, data may be directly transmitted between user terminals without through network-side devices such as base stations, thereby reducing latency, increasing network capacity, improving spectrum efficiency and the like.

In addition, in order to improve safety and intelligence of a transportation system, Vehicle to Everything (V2X) has been proposed. V2X requires low communication latency between vehicles, large network capacity and the like. Since D2D technology has significant advantages in latency, network capacity and the like, D2D technology is used as a basic support technology of V2X.

For V2X, a variety of allocation modes for transmission resources have been proposed, such as a base station-scheduling based resource allocation mode, a user terminal (which may be a car or a roadside unit in V2X)-autonomous-selection resource allocation mode, or a user terminal-scheduling based resource allocation mode. In the user terminal-scheduling based resource allocation mode, a plurality of user terminals may form a user terminal group, and one of the plurality of user terminals serves as a header-user terminal (header-UE) while the remaining user terminals of the plurality of user terminals serve as member-user terminals (member-UEs), where the header-user terminal is used to control or schedule the member-user terminals. For example, the header-user terminal may allocate resources to the member-user terminals. Specifically, resources or a set of resources for the user terminal group may be determined firstly, and then the header-user terminal allocates, in the resources or the set of resources for the user terminal group, resources to the member-user terminals.

Resources of a communication system are limited. Therefore, there is a situation in which different user terminal groups use the same resources or resource set. In this situation, resources allocated by a header-user terminal of a first user terminal group to member-user terminals of its group may be the same as resources allocated by a header-user terminal of a second user terminal group to member-user terminals of its group. When these user terminals using the same resources become closer due to movement, interference will be caused between these user terminals using the same resources, which reduces communication quality. In addition, when the header-user terminal of the first user terminal group is located within a coverage area of the header-user terminal of the second user terminal group, it will also cause interference between the header-user terminal of the first user terminal group and the header-user terminal of the second user terminal group and a reduced resource reuse rate.

### SUMMARY OF THE DISCLOSURE

According to one aspect of the present disclosure, a first-type user terminal is provided, comprising: a control unit configured to acquire detection information for another first-type user terminal, wherein the first-type user terminal is used to control a second-type user terminal, and the first-type user terminal and the second-type user terminal belong to one user terminal group; determine whether to regroup the user terminal group at least according to the acquired detection information; and regroup the user terminal group when it is determined to regroup the user terminal group.

According to another aspect of the present disclosure, a method performed by a first-type user terminal is provided, the method comprising: acquiring detection information for another first-type user terminal, wherein the first-type user terminal is used to control a second-type user terminal, and the first-type user terminal and the second-type user terminal belong to one user terminal group; determining whether to regroup the user terminal group at least according to the acquired detection information; and regrouping the user terminal group when it is determined to regroup the user terminal group.

According to one example of the present disclosure, the above method further comprises: determining whether to reselect resources for the user terminal group at least according to the acquired detection information; and when it is determined to reselect resources for the user terminal group, reselecting resources for the user terminal group.

According to one example of the present disclosure, wherein the acquiring detection information for another first-type user terminal includes: detecting a discovery signal of the another first-type user terminal to acquire the detection information.

According to one example of the present disclosure, wherein the discovery signal is a first-type discovery signal, and the first-type discovery signal is used for the second-type user terminal to detect the another first-type user terminal.

According to one example of the present disclosure, wherein the detecting a discovery signal of the another first-type user terminal includes: detecting the first-type discovery signal of the another first-type user terminal when muting the first-type discovery signal of the first-type user terminal.

According to one example of the present disclosure, the above method further comprises: determining a probability of muting the first-type discovery signal of the first-type user terminal at a transmission occasion of the first-type discovery signal of the first-type user terminal; and muting the first-type discovery signal of the first-type user terminal at the transmission occasion according to the probability.

According to one example of the present disclosure, wherein the muting the first-type discovery signal of the first-type user terminal according to the probability at the transmission occasion includes: muting the first-type discovery signal of the first-type user terminal according to the probability at the transmission occasion and on specific resources of a plurality of resources corresponding to the transmission occasion.

According to one example of the present disclosure, the above method further comprises: determining a muting pattern for a transmission occasion of the first-type discovery signal of the first-type user terminal; and muting the first-type discovery signal of the first-type user terminal at the transmission occasion according to the muting pattern.

According to one example of the present disclosure, wherein the muting the first-type discovery signal of the first-type user terminal according to the probability at the transmission occasion includes: determining, according to the muting pattern, whether to mute the first-type discovery signal of the first-type user terminal on each of a plurality of resources corresponding to the transmission occasion; and muting the first-type discovery signal of the first-type user terminal according to a determination result.

According to one example of the present disclosure, wherein the discovery signal is a second-type discovery signal, and the second-type discovery signal is used for the first-type user terminal to detect the another first-type user terminal.

According to one example of the present disclosure, the detecting a discovery signal of the another first-type user terminal includes: detecting a dedicated signal of the another first-type user terminal, and wherein the dedicated signal includes at least information carried by the discovery signal of the another first-type user terminal.

According to one example of the present disclosure, wherein the acquiring detection information for another first-type user terminal includes: receiving the detection information from the second-type user terminal, and wherein the detection information is acquired by the second-type user terminal detecting the discovery signal of the another first-type user terminal

According to one example of the present disclosure, wherein the detection information is measurement information acquired by the second-type user terminal detecting the discovery signal of the another first-type user terminal and measuring the another first-type user terminal according to the discovery signal of the another first-type user terminal.

According to one example of the present disclosure, the above method further comprises: receiving, from the second-type user terminal, the measurement information of the second-type user terminal for the first-type user terminal; wherein the determining whether to regroup the user terminal group at least according to the acquired detection information includes: determining whether to regroup the user terminal group according to the acquired detection information and the measurement information of the second-type user terminal for the first-type user terminal.

### BRIEF DESCRIPTION OF THE DRAWINGS

The foregoing and other objectives, features and advantages of the present disclosure will become clearer from more detailed description of embodiments of the present disclosure in conjunction with accompanying drawings. The accompanying drawings are used to provide a further understanding of the embodiments of the present disclosure, constitute a part of this specification, and help to explain the present disclosure together with the embodiments of the present disclosure, but are not intended to act as a limitation of the present disclosure. In the accompanying drawings, like reference numerals usually indicate like components or steps.

FIG. 1 is a schematic diagram of a wireless communication system in which the embodiments of the present disclosure may be applied.

FIG. 2 is a flowchart of a method performed by a first-type user terminal according to a first embodiment of the present disclosure.

FIG. 3 is one example of determining a muting pattern for a transmission occasion of a first-type discovery signal of the first-type user terminal according to a first implementation of the first embodiment of the present disclosure.

FIG. 4 is a schematic diagram of first-type discovery signals and second-type discovery signals according to a second implementation of the first embodiment of the present disclosure.

FIG. 5 is a flowchart of a method performed by a first-type user terminal according to a second embodiment of the present disclosure.

FIG. 6 is a schematic structural diagram of a first-type user terminal according to the first embodiment of the present disclosure.

FIG. 7 is a schematic structural diagram of a first-type user terminal according to the second embodiment of the present disclosure.

FIG. 8 is a schematic diagram of a hardware structure of a device involved in an embodiment of the present disclosure.

### DESCRIPTION OF THE EMBODIMENTS

In order to make objectives, technical solutions and advantages of the present disclosure clearer, exemplary embodiments according to the present disclosure will be described in detail below with reference to the accompanying drawings. Like reference numerals refer to like elements throughout the accompanying drawings. It should be understood that the embodiments described herein are merely illustrative and should not be constructed as limiting the scope of the present disclosure. In addition, user terminals described herein may include various types of user equipment (UEs), for example, mobile terminals (or referred to as mobile stations) or fixed terminals. However, for the sake of convenience, UEs and mobile terminals sometimes may be used interchangeably hereinafter.

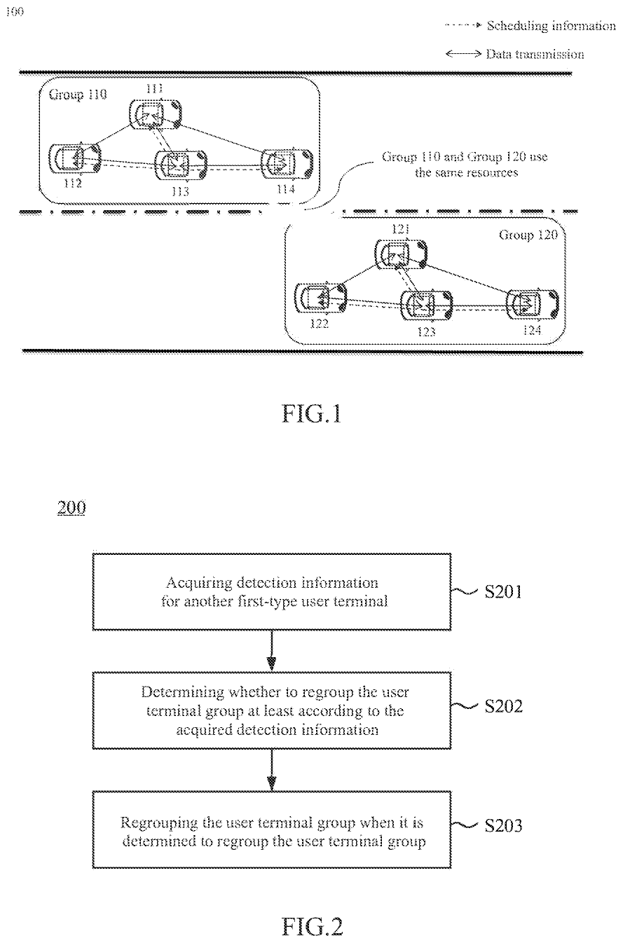

First, a wireless communication system in which the embodiments of the present disclosure may be applied will be described with referenced to FIG. 1. The wireless communication may be a 5G system, or may be any other type of wireless communication system such as a Long Term Evolution (LTE) system, an LTE-advanced (LTE-A) system and the like. In the following, a 5G system is taken as an example to describe the embodiments of the present disclosure, but it should be appreciated that the following description may also be applied to other types of wireless communication systems.

As shown in FIG. 1, a wireless communication system 100 may include a first user terminal group 110 and a second user terminal group 120, where the first user terminal group 110 may include a first-type user terminal 111 and second-type user terminals 112, 113 and 114, and the first-type user terminal 111 is used to control or schedule the second-type user terminals 112, 113 and 114; similarly, the second user terminal group 120 may include a first-type user terminal 121 and second-type user terminals 122, 123 and 124, and the first-type user terminal 121 is used to control or schedule the second-type user terminals 122, 123 and 124. For example, taking the first user terminal group 110 as an example and as shown by dashed lines in FIG. 1, the first-type user terminal 111 may transmit scheduling information to the second-type user terminals 112, 113 and 114, respectively, so as to schedule resources used for the second-type user terminals 112, 113 and 114. Since a first-type user terminal has the ability to control or schedule second-type user terminals in a user terminal group, the first-type user terminal may also be referred as a header-user terminal (header-UE), a control user terminal, a scheduling user terminal, a cluster header, a local manager, or any user terminal with a control or scheduling capability. Accordingly, a second-type user terminal may be referred to as a member-user terminal (member-UE), a controlled user terminal, a scheduled user terminal, a cluster member, or any user terminal that is controlled or scheduled.

In addition, data transmission may be performed between user terminals in a user terminal group. For example, taking the first user terminal group 110 as an example and as shown by solid lines in FIG. 1, data transmission may be performed between the first-type user terminal 111, the second-type user terminal 112, the second-type user terminal 113, and the second-type user terminal 114.

It should be appreciated hat although two first-type user terminals and six second-type user terminals are shown in FIG. 1, this is only illustrative, and the wireless communication system may include fewer or more first-type user terminals, and/or fewer or more second-type user terminals. Accordingly, the wireless communication system may include fewer or more user terminal groups.

In addition, the above user terminals may be user terminals (pre)configured to camp on a resource pool (pre)configured for a Medium Access Control (MAC) structure corresponding to the user terminal-scheduling based resource allocation mode.

In addition, although it is described above that the first-type user terminals and the second-type user terminals are all user terminals, the present disclosure is not limited thereto. The first-type user terminals and the second-type user terminals may also be communication devices on the network side, such as base stations. For example, the first-type user terminals may be base stations, and the second-type user terminals may be user terminals.

In the above communication system, resources or a set of resources for each user terminal group may be determined firstly, and then, a first-type user terminal in each user terminal group allocates, in the resources or the set of resources for the corresponding user terminal group, resources to second-type user terminals of the corresponding user terminal group. Since resources of the communication system are limited, there is a situation in which different user terminal groups use the same resources or resource set. In this situation, resources allocated by a first-type user terminal of a first user terminal group to second-type user terminals of its group may be the same as resources allocated by a first-type user terminal of a second user terminal group to second-type user terminals of its group. When these user terminals using the same resources become closer due to movement, interference will be caused between these user terminals using the same resources, which reduces communication quality. For example, the first user terminal group 110 and the second user terminal group 120 described above may use a same resource set, and resources allocated by the first-type user terminal 111 of the first user terminal group 110 to the second-type user terminal 112 of this group are the same as resources allocated by the first-type user terminal 121 of the second user terminal group 120 to the second-type user terminal 122 of this group, and thus when the second-type user terminal 112 and the second-type user terminal 122 become closer due to movement, interference will be caused between the second-type user terminal 112 and the second-type user terminal 122, which reduces communication quality. The purpose of the present disclosure is to provide a first-type user terminal and a method performed by the first-type user terminal, so as to reduce interference between user terminals and avoid the reduced resource reuse rate.

In the present disclosure, user terminals in the communication system may be regrouped, and/or resources or resource sets used for respective user terminal groups may be re-determined, to ensure that a plurality of adjacent user terminal groups use resources or resource sets that are orthogonal to each other, thereby avoiding interference between user terminal groups and improving communication quality. For example, user terminals in the communication system may be regrouped periodically, and/or resources or resource sets used for respective user terminal groups may be re-determined periodically. As another example, regrouping of user terminals in the communication system may be triggered by certain specific events, and/or re-determination of resources or resource sets used for respective user terminal groups may be triggered by certain specific events. The periodic regrouping and/or periodic re-determination of resources for respective user terminal groups may be determined through definitions or (pre)configurations of communication standard protocol specifications such as 3GPP and the like, or regrouping of user terminals and/or re-determination of resources for respective user terminal groups may be triggered by a specific event. The present disclosure will be described below by taking the example in which regrouping of user terminals and/or re-determination of resources for respective user terminal groups is triggered by a specific event.

A method performed by a first-type user terminal according to a first embodiment of the present disclosure will be described below with reference to FIG. 2. FIG. 2 is a flowchart of a method 200 performed by a first-type user terminal according to the first embodiment of the present disclosure. As shown in FIG. 2, in step S201, a first-type user terminal acquires detection information for another first-type user terminal, where the first-type user terminal is used to control a second-type user terminal, and the first-type user terminal and the second-type user terminal belong to one user terminal group. Hereinafter, the “first-type user terminal” being the “first-type user terminal 111” described above, and the “another first-type user terminal” being the “first-type user terminal 121” described above will be taken as an example to describe the first embodiment of the present disclosure.

In the first embodiment of the present disclosure, the first-type user terminal 111 acquiring detection information for the first-type user terminal 121 may include: the first-type user terminal 111 detecting a discovery signal of the first-type user terminal 121 to acquire the detection information.

The discovery signal may be any signal (or may also be referred to as signaling) used to detect the first-type user terminal 121. For example, the discovery signal may be a Sidelink Synchronization Signal (SLSS). As another example, the discovery signal may be a signal transmitted on a Physical Sidelink Broadcast Channel (PSBCH).

In addition, the discovery signal may carry auxiliary information, which may assist the first-type user terminal 111 to measure/sense the first-type user terminal 121 after detecting the first-type user terminal 121, to acquire the detection information. For example, the auxiliary information may assist the first-type user terminal 111 to measure/sense strength of a signal transmitted by the first-type user terminal 121 to acquire a measurement/sensing result. In this case, the measurement/sensing result may be the detection information of the first-type user terminal 111 for the first-type user terminal 121. In addition, the measurement/sensing result may be, for example, one or more of Reference Signal Receiving Power (RSRP), Received Signal Strength Indication (RSSI), Reference Signal Receiving Quality (RSRQ), Signal to Interference plus Noise Ratio (SINR), Signal to Noise Ratio (SNR) and the like.

The auxiliary information mentioned herein may be attribute information of the first-type user terminal 121. For example, the attribute information of the first-type user terminal 121 may include identification information of the first-type user terminal 121, for example, one or more of ID, Service Set Identifier (SSID), Radio Network Temporary Identity (RNTI) and the like of the first-type user terminal 121.

As another example, the attribute information of the first-type user terminal 121 may also include movement information of the first-type user terminal 121, for example, one or more of an average speed, a maximum speed and the like of the first-type user terminal 121.

As another example, the attribute information of the first-type user terminal 121 may also include location information of the first-type user terminal 121, for example, one or more of a geographic location (such as an absolute location or an area ID, etc.) of the first-type user terminal 121, a relative location between the first-type user terminal 121 and a proximity user terminal that does not belong to any user terminal group, an average distance between the first-type user terminal 121 and proximity user terminals that do not belong to any user terminal group, and the like. In the present disclosure, a proximity user terminal may be determined by the first-type user terminal 121 performing signal measurement on other user terminals. For example, the first-type user terminal 121 performs signal measurement on other user terminal to obtain a measurement result (for example, signal receiving quality), and when the measurement result is greater than a first threshold, the other user terminal may be the proximity communication device of the first-type user terminal 121. In addition, the proximity user terminal may also be determined according to locations of the first-type user terminal 121 and other user terminal. For example, when a linear distance between the other user terminal and the first-type user terminal 121 is less than a predetermined threshold, the other user terminal may be the proximity user terminal of the first-type user terminal 121.

As another example, the attribute information of the first-type user terminal 121 may also include a measurement/sensing result of the first-type user terminal 121 for a proximity user terminal that does not belong to any user terminal group. The measurement/sensing result may be a measurement result of the first-type user terminal 121 for strength of a signal received from the proximity user terminal that does not belong to any user terminal group, for example, one or more of RSRP, RSSI, RSRQ, SINR, SNR and the like.

As another example, the attribute information of the first-type user terminal 121 may also include information about the number of proximity user terminals that do not belong to any user terminal group, for example, the number of proximity user terminals that do not belong to any user terminal group during a predetermined period of time.

As another example, the attribute information of the first-type user terminal 121 may also include priority information for the first-type user terminal 121 to serve as a first-type user terminal. For example, a priority may be defined based on a determination manner of the first-type user terminal. For example, when the first-type user terminal is determined through high layer signaling, the priority for the first-type user terminal 121 to serve as a first-type user terminal may be set to 1; when the first-type user terminal is determined through a (pre)configuration, the priority for the first-type user terminal 121 to serve as a first-type user terminal may be set to 2; when the first-type user terminal is determined through an automatic selection, the priority for the first-type user terminal 121 to serve as a first-type user terminal may be set to 3.

As another example, the attribute information of the first-type user terminal 121 may also include class information of the first-type user terminal 121, for example, a class identifier of the first-type user terminal 121, such as a class identifier of the first-type user terminal 121 belonging to a bus, a truck, a car or the like.

It should be appreciated that although the above examples describe that the attribute information of the first-type user terminal 121 may include the identification information of the first-type user terminal 121, the movement information of the first-type user terminal 121, the location information of the first-type user terminal 121, the measurement/sensing result of the first-type user terminal 121 for a proximity user terminal that does not belong to any user terminal group, the information about the number of proximity user terminals that do not belong to any user terminal group, the priority information for serving as a first-type user terminal, and/or the class information of the first-type user terminal 121, the present disclosure is not limited thereto. According to other examples, the attribute information of the first-type user terminal 121 may further include any other attribute information of the first-type user terminal 121.

According to a first implementation of the first embodiment of the present disclosure, the discovery signal of the first-type user terminal 121 may be a first-type discovery signal, and the first-type discovery signal may be used for a second-type user terminal (for example, the second-type user terminal 122, 123 or 124) to detect the first-type user terminal 121.

In the first implementation, the first-type user terminal 111 detecting a discovery signal of the first-type user terminal 121 may include: the first-type user terminal 111 detecting the first-type discovery signal of the first-type user terminal 121 when muting a first-type discovery signal of the first-type user terminal 111. Due to a half-duplex communication mode of the user terminals, the user terminals can only perform one of transmitting operation and receiving operation at a certain moment. Therefore, the first-type user terminal 111 may not transmit its own first-type discovery signal (that is, mute its own first-type discovery signal) at certain moments, so as to be able to receive the first-type discovery signal of the first-type user terminal 121 at these moments, to detect the first-type discovery signal of the first-type user terminal 121, thereby realizing detection of the first-type user terminal 121.

According to a first example of the first implementation, the method 200 may further include: determining a probability of muting the first-type discovery signal of the first-type user terminal 111 at a transmission occasion of the first-type discovery signal of the first-type user terminal 111. As described above, the discovery signal may be SLSS/PSBCH. Therefore, the transmission occasion of the first-type discovery signal of the first-type user terminal 111 may be an SLSS/PSBCH transmission occasion.

In the first example, the probability of muting the first-type discovery signal of the first-type user terminal 111 at the transmission occasion of the first-type discovery signal of the first-type user terminal 111 may be, for example, a probability defined by communication standard protocol specifications such as 3GPP and the like. For example, the probability may be 10%, 20%, 50% or the like.

As another example, the probability of muting the first-type discovery signal of the first-type user terminal 111 at the transmission occasion of the first-type discovery signal of the first-type user terminal 111 may also be a (pre)configured probability. For example, the probability may be written into a SIM card of the user terminal, or may be a probability configured by a base station after the user terminal accesses the base station. For example, the probability may be 10%, 20% or 50%.

As another example, the probability of muting the first-type discovery signal of the first-type user terminal 111 at the transmission occasion of the first-type discovery signal of the first-type user terminal 111 may also be a probability selected from a probability range defined by communication standard protocol specifications such as 3GPP and the like or a (pre)configured probability range. For example, the first-type user terminal 111 may randomly select a probability from the probability range as the probability of muting the first-type discovery signal of the first-type user terminal 111. For example, the probability range may be 10%˜50%, and the first-type user terminal 111 may select 40% from the probability range as the probability of muting the first-type discovery signal of the first-type user terminal 111 at the transmission occasion of the first-type discovery signal of the first-type user terminal 111.

As another example, the probability of muting the first-type discovery signal of the first-type user terminal 111 at the transmission occasion of the first-type discovery signal of the first-type user terminal 111 may also be determined based on a preset rule. The preset rule may be a preset function, such as a utility function. An input of the utility function may be the attribute information of the first-type user terminal 111, and an output of the utility function may be associated with the probability.

Although a plurality of methods for determining the probability of muting the first-type discovery signal of the first-type user terminal 111 have been described above, it should be understood that, for a plurality of user terminals, probabilities of respective user terminals muting first-type discovery signals may be determined respectively by adopting a same determining method. Alternatively, probabilities of respective user terminals muting first-type discovery signals may also be determined respectively by adopting different determining methods for different user terminals.

Furthermore, it should be appreciated that, in addition to the plurality of methods described above for determining the probability of muting the first-type discovery signal of the first-type user terminal 111, the present disclosure may also include any other methods for determining the probability of muting the first-type discovery signal of the first-type user terminal 111.

In addition, in the first example, determining a probability of muting the first-type discovery signal of the first-type user terminal 111 at a transmission occasion of the first-type discovery signal of the first-type user terminal 111 may be determining a probability of muting the first-type discovery signal of the first-type user terminal 111 at each transmission occasion of the first-type discovery signal of the first-type user terminal 111.

In this case, the probability of muting the first-type discovery signal of the first-type user terminal 111 at each transmission occasion of the first-type discovery signal of the first-type user terminal 111 may be the same. For example, the probability of muting the first-type discovery signal of the first-type user terminal 111 at each transmission occasion of the first-type discovery signal of the first-type user terminal 111 may be 20%.

In addition, in this case, the probability of muting the first-type discovery signal of the first-type user terminal 111 at each transmission occasion of the first-type discovery signal of the first-type user terminal 111 may be different. For example, a probability of muting the first-type discovery signal of the first-type user terminal 111 at a first transmission occasion of the first-type discovery signal of the first-type user terminal 111 may be 10%; a probability of muting the first-type discovery signal of the first-type user terminal 111 at a second transmission occasion of the first-type discovery signal of the first-type user terminal 111 may be 80%; a probability of muting the first-type discovery signal of the first-type user terminal 111 at a third transmission occasion of the first-type discovery signal of the first-type user terminal 111 may be 10%, and so on.

Alternatively, determining a probability of muting the first-type discovery signal of the first-type user terminal 111 at a transmission occasion of the first-type discovery signal of the first-type user terminal 111 may be determining a probability of muting the first-type discovery signal of the first-type user terminal 111 at one or more specific transmission occasions of the first-type discovery signal of the first-type user terminal 111. For example, only a probability of muting the first-type discovery signal of the first-type user terminal 111 at the second transmission occasion of the first-type discovery signal of the first-type user terminal 111 may be determined, for example, 80%.

In addition, in the first example, after determining the probability of muting the first-type discovery signal of the first-type user terminal 111 at a transmission occasion of the first-type discovery signal of the first-type user terminal 111, the method 200 may further include: muting the first-type discovery signal of the first-type user terminal 111 according to the probability at the transmission occasion.

The SLSS/PSBCH transmission occasion described above may correspond to a plurality of resources, and SLSS/PSBCH may be transmitted on each of the plurality of resources. Therefore, if the first-type discovery signal of the first-type user terminal 111 is not muted, the first-type discovery signal of the first-type user terminal 111 may be transmitted at the SLSS/PSBCH transmission occasion and on each of the plurality of resources corresponding to the SLSS/PSBCH transmission occasion. However, in the first example, in order to detect the first-type discovery signal of the first-type user terminal 121, the first-type user terminal 111 may mute the first-type discovery signal of the first-type user terminal 111 at the transmission occasion and on specific resources of the plurality of resources corresponding to the transmission occasion. For example, in the first example, the first-type user terminal 111 may mute the first-type discovery signal of the first-type user terminal 111 according to the probability at the transmission occasion and on the specific resources of the plurality of resources corresponding to the transmission occasion.

In addition, in the first example, the first-type user terminal 111 can only mute the first-type discovery signal of the first-type user terminal 111 on the specific resources of the plurality of resources corresponding to the transmission occasion, rather than mute the first-type discovery signal of the first-type user terminal 111 on each resource of the plurality of resources corresponding to the transmission occasion. This ensures that a second-type user terminal (for example, the second-type user terminal 112, 113 or 114) can detect the first-type user terminal 111, and can receive, from the first-type user terminal 111, control or scheduling signaling of the first-type user terminal 111 to the second-type user terminal, so as to accept the control or scheduling of the first-type user terminal 111.

The specific resources mentioned herein may be resources defined by communication standard protocol specifications such as 3GPP and the like, or (pre)configured resources. For example, the specific resource may be odd-numbered resources or even-numbered resources of the plurality of resources corresponding to the SLSS/PSBCH transmission occasion. For example, assuming that the plurality of resources corresponding to the SLSS/PSBCH transmission occasion are 5 resources and the specific resources may be the second and fourth resources, the first-type user terminal 111 may not mute the first-type discovery signal of the first-type user terminal 111 on the first resource of the 5 resources corresponding to the SLSS/PSBCH transmission occasion, mute the first-type discovery signal of the first-type user terminal 111 on the second resource of the 5 resources corresponding to the SLSS/PSBCH transmission occasion, not mute the first-type discovery signal of the first-type user terminal 111 on the third resource of the 5 resources corresponding to the SLSS/PSBCH transmission occasion, mute the first-type discovery signal of the first-type user terminal 111 on the fourth resource of the 5 resources corresponding to the SLSS/PSBCH transmission occasion, and not mute the first-type discovery signal of the first-type user terminal 111 on the fifth resource of the 5 resources corresponding to the SLSS/PSBCH transmission occasion.

In addition, in the first example, since the attribute information of the first-type user terminal 111 may out of date which results in inaccurate probability of the first-type user terminal 111 muting the first-type discovery signal, when muting the first-type discovery signal of the first-type user terminal 111 according to the probability at the transmission occasion, an actual muting probability of the first-type user terminal 111 at the transmission occasion may be determined firstly, then the actual muting probability and the probability may be compared, and the first-type discovery signal of the first-type user terminal 111 is muted according to the comparison result. For example, when the actual muting probability of the first-type user terminal 111 at the transmission occasion is greater than the probability, the first-type user terminal 111 mutes the first-type discovery signal of the first-type user terminal 111 at the transmission occasion; and when the actual muting probability of the first-type user terminal 111 at the transmission occasion is less than the probability, the first-type user terminal 111 does not mute the first-type discovery signal of the first-type user terminal 111 at the transmission occasion.

In addition, in the first example, muting the first-type discovery signal of the first-type user terminal 111 according to the probability at the transmission occasion may include: muting the first-type discovery signal of the first-type user terminal 111 at the transmission occasion according to a relationship between the probability and a predetermined threshold. For example, when the probability is greater than the predetermined threshold, the first-type discovery signal of the first-type user terminal 111 is muted at the transmission occasion; and when the probability is less than the predetermined threshold, the first-type discovery signal of the first-type user terminal 111 is not muted at the transmission occasion.

According to a second example of the first implementation, the method 200 may further include: determining a muting pattern for a transmission occasion of the first-type discovery signal of the first-type user terminal 111. The muting pattern may be represented by a bit sequence, for example, where a length of the bit sequence may be equal to the number of the plurality of resources corresponding to the transmission occasion, a plurality of bits in the bit sequence respectively correspond to the plurality of resources, and values of the plurality of bits indicate whether to mute the first-type discovery signal on the plurality of resources. For example, when a value of a bit is 1, the first-type discovery signal is not muted on one of the plurality of resources corresponding to the bit; and when the value of the bit is 0, the first-type discovery signal is muted on one of the plurality of resources corresponding to the bit.

For example, assuming that the plurality of resources corresponding to the transmission occasion are 5 resources, the muting pattern may be a bit sequence with a length of 5, such as a bit sequence [10101]. The values of the 5 bit in the bit sequence respectively represent that: not muting the first-type discovery signal on the first resource of the 5 resources corresponding to the transmission occasion, muting the first-type discovery signal on the second resource of the 5 resources corresponding to the transmission occasion, not muting the first-type discovery signal on the third resource of the 5 resources corresponding to the transmission occasion, muting the first-type discovery signal on the fourth resource of the 5 resources corresponding to the transmission occasion, and not muting the first-type discovery signal on the fifth resource of the 5 resources corresponding to the transmission occasion.

In the second example, for example, the muting pattern may be a bit sequence defined by communication standard protocol specifications such as 3GPP and the like. For example, the bit sequence may be [10101].

As another example, the muting pattern may also be a (pre)configured bit sequence. For example, the bit sequence may be written into a SIM card of a user terminal, or may be a bit sequence configured by a base station after the user terminal accesses the base station. For example, the bit sequence may be [10101].

As another example, the muting pattern may also be a bit sequence selected from candidate bit sequences defined by communication standard protocol specifications such as 3GPP and the like or (pre)configured candidate bit sequences. For example, the first-type user terminal 111 may randomly select a bit sequence from the candidate bit sequences as the muting pattern for muting the first-type discovery signal of the first-type user terminal 111. For example, the candidate bit sequences may include [10101], [11101], [10111] and so on, and the firs-type user terminal 111 may select [10101] from the candidate bit sequences as the muting pattern for muting the first-type discovery signal of the first-type user terminal 111 at the transmission occasion of the first-type discovery signal of the first-type user terminal 111.

As another example, the muting pattern may also be determined based on a preset rule. The preset rule may be a preset function, such as a utility function. An input of the utility function may be the attribute information of the first-type user terminal 111, and an output of the utility function may be associated with the muting pattern.

In addition, the length of the bit sequence as the muting pattern may be defined by, for example, communication standard protocol specifications such as 3GPP and the like. As another example, the length of the bit sequence as the muting pattern may be (pre)configured. As another example, the length of the bit sequence as the muting pattern may be selected from a range of bit sequence lengths defined by communication standard protocol specifications such as 3GPP and the like, or a (pre)configured range of bit sequence lengths. As another example, the length of the bit sequence as the muting pattern may be determined based on a preset rule. However, the present disclosure is not limited thereto, and the present disclosure may further include any other methods for determining the length.

Various methods for determining the muting pattern of muting the first-type discovery signal of the first-type user terminal 111 have been described above. It should be understood that, for a plurality of user terminals, muting patterns for respective user terminals muting first-type discovery signals may be determined respectively by adopting a same determining method. Alternatively, muting patterns for respective user terminals muting first-type discovery signals may also be determined respectively by adopting different determining methods for different user terminals.

It should be appreciated that, in addition to the plurality of methods described above for determining the muting pattern of muting the first-type discovery signal of the first-type user terminal 111, the present disclosure may further include any other methods for determining the muting pattern of muting the first-type discovery signal of the first-type user terminal 111.

In addition, in the second example, determining a muting pattern for a transmission occasion of the first-type discovery signal of the first-type user terminal 111 may be determining a muting pattern for each transmission occasion of the first-type discovery signal of the first-type user terminal 111.

In this case, the muting pattern for each transmission occasion of the first-type discovery signal of the first-type user terminal 111 may be the same. For example, the muting pattern for each transmission occasion of the first-type discovery signal of the first-type user terminal 111 may be [10101].

In addition, in this case, the muting pattern for each transmission occasion of the first-type discovery signal of the first-type user terminal 111 may be different. For example, a muting pattern for a first transmission occasion of the first-type discovery signal of the first-type user terminal 111 may be [10101]; a muting pattern for a second transmission occasion of the first-type discovery signal of the first-type user terminal 111 may be [11101]; a muting pattern for a third transmission occasion of the first-type discovery signal of the first-type user terminal 111 may be [10111], and so on.

Alternatively, in the second example, determining a muting pattern for a transmission occasion of the first-type discovery signal of the first-type user terminal 111 may be determining a muting pattern for one or more specific transmission occasions of the first-type discovery signal of the first-type user terminal 111. For example, only the muting pattern for the second transmission occasion of the first-type discovery signal of the first-type user terminal 111 may be determined, for example, [11101].

In addition, in the second example, determining a muting pattern for a transmission occasion of the first-type discovery signal of the first-type user terminal 111 may be determining one or more common muting patterns for all first-type user terminals 111. When there is one common muting pattern, the muting pattern for the transmission occasion of the first-type discovery signal of the first-type user terminal 111 may be the common muting pattern. When there are a plurality of common muting patterns, the first-type user terminal 111 may select one of the plurality of common muting patterns as the muting pattern for the transmission occasion of the first-type discovery signal of the first-type user terminal 111. For example, the first-type user terminal 111 may randomly select one of the plurality of common muting patterns as the muting pattern for the transmission occasion of the first-type discovery signal of the first-type user terminal 111. As another example, the first-type user terminal 111 may select, based on the attribute information of the first-type user terminal 111, one of the plurality of common muting patterns as the muting pattern for the transmission occasion of the first-type discovery signal of the first-type user terminal 111.

Alternatively, in the second example, determining a muting pattern for a transmission occasion of the first-type discovery signal of the first-type user terminal 111 may be determining a dedicated muting pattern for the first-type user terminal 111. For example, a muting pattern for the first-type user terminal 111 of the first user terminal group may be [10101], and a muting pattern for the first-type user terminal 121 of the second user terminal group may be [11101].

In addition, in the second example, determining a muting pattern for a transmission occasion of the first-type discovery signal of the first-type user terminal 111 may be periodically determining a muting pattern for a transmission occasion of the first-type discovery signal of the first-type user terminal 111. For example, the first-type user terminal 111 may determine a muting pattern every other time granularity, and use the determined muting pattern as a muting pattern for a next transmission occasion of the first-type discovery signal of the first-type user terminal 111. The time granularity mentioned herein may be a specific time period (in seconds or milliseconds), a Transmission Time Interval (TTI), a symbol, a time slot, a mini-slot, a subframe, a frame, an SLSS/PSBCH transmission occasion or the like.

Alternatively, in the second example, determining a muting pattern for a transmission occasion of the first-type discovery signal of the first-type user terminal 111 may be: the first-type user terminal 111 being triggered by a specific event to re-determine a muting pattern for the transmission occasion of the first-type discovery signal of the first-type user terminal 111. For example, the specific event may be that the number of times that the first-type user terminal 111 continuously uses a same muting pattern is greater than or equal to a predetermined threshold. The predetermined threshold may be defined by communication standard protocol specifications such as 3GPP and the like, or (pre)configured, for example, the predetermined threshold may be 3. In addition, the predetermined threshold may also be a threshold selected from a threshold range defined by communication standard protocol specifications such as 3GPP and the like, or a (pre)configured threshold range. For example, the first-type user terminal 111 may randomly select a threshold from the threshold range as the specific threshold. For example, the threshold range may be 2˜10, and the first-type user terminal 111 may select 5 from the threshold range as the specific threshold. However, the present disclosure is not limited thereto. According to other examples, the predetermined threshold may also be determined in any other manner.

For example, assuming that the predetermined threshold is 3, after the first-type user terminal 111 mutes the first-type discovery signal at the first to third transmission occasions of the first-type discovery signal of the first-type user terminal 111 by using the muting pattern [10101], since the first-type user terminal 111 has used the muting pattern [10101] for three consecutive times, the first-type user terminal 111 may re-determine a muting pattern for the fourth transmission occasion of the first-type discovery signal of the first-type user terminal 111, for example, [10111]. That is, after using a same muting pattern multiple times, the first-type user terminal 111 may change the muting pattern. The value of the predetermined threshold mentioned herein may be defined by communication standard protocol specifications such as 3GPP and the like or (pre) configured, or may also be determined in any other manner.

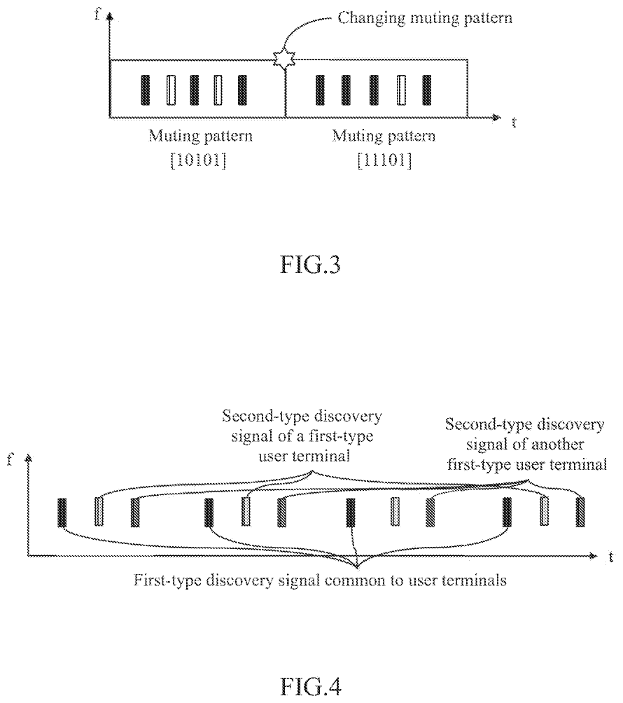

An example of determining a muting pattern for a transmission occasion of the first-type discovery signal of the first-type user terminal 111 according to the second example will be described below with reference to FIG. 3. As shown in FIG. 3, a black box represents “transmitting the first-type discovery signal” and a white box represents “muting the first-type discovery signal”. In addition, as shown in FIG. 3, a muting pattern for a first transmission occasion of the first-type discovery signal of the first-type user terminal 111 is [10101], and therefore, the first-type user terminal 111 transmits the first-type discovery signal on the first resource of 5 resources corresponding to the first transmission occasion, mutes the first-type discovery signal on the second resource of the 5 resources corresponding to the first transmission occasion, transmits the first-type discovery signal on the third resource of the 5 resources corresponding to the first transmission occasion, mutes the first-type discovery signal on the fourth resource of the 5 resources corresponding to the first transmission occasion, and transmits the first-type discovery signal on the fifth resource of the 5 resources corresponding to the first transmission occasion. In addition, as shown in FIG. 3, the first-type user terminal 111 re-determines the muting pattern as [11101] at a second transmission occasion, and uses the re-determined muting pattern as a muting pattern for the second transmission occasion of the first-type discovery signal of the first-type user terminal 111. Therefore, the first-type user terminal 111 transmits the first-type discovery signal on the first resource of 5 resources corresponding to the second transmission occasion, transmits the first-type discovery signal on the second resource of the 5 resources corresponding to the second transmission occasion, transmits the first-type discovery signal on the third resource of the 5 resources corresponding to the second transmission occasion, mutes the first-type discovery signal on the fourth resource of the 5 resources corresponding to the second transmission occasion, and transmits the first-type discovery signal on the fifth resource of the 5 resources corresponding to the second transmission occasion.

In addition, in the second example, after determining the muting pattern for a transmission occasion of the first-type discovery signal of the first-type user terminal 111, the method 200 may further include: muting the first-type discovery signal of the first-type user terminal 111 at the transmission occasion according to the muting pattern. For example, as described above, the muting pattern may indicate whether to mute the first-type discovery signal on the plurality of resources corresponding to the transmission occasion. Therefore, muting the first-type discovery signal of the first-type user terminal 111 at the transmission occasion according to the muting pattern may include: determining, according to the muting pattern, whether to mute the first-type discovery signal of the first-type user terminal 111 on each of the plurality of resources corresponding to the transmission occasion; and muting the first-type discovery signal of the first-type user terminal according to a determination result.

For example, the first-type user terminal 111 may determine, according to the muting pattern [10101], to mute the first-type discovery signal of the first-type user terminal 111 on the second and the fourth resources of 5 resources corresponding to the transmission occasion, and not to mute the first-type discovery signal of the first-type user terminal 111 on the first, the third and the fifth resources of the 5 resources corresponding to the transmission occasion. Then, the first-type user terminal 111 may mute the first-type discovery signal of the first-type user terminal 111 on the second and the fourth resources of the 5 resources corresponding to the transmission occasion, and not mute the first-type discovery signal of the first-type user terminal 111 on the first, the third and the fifth resources of the 5 resources corresponding to the transmission occasion according to a determination result.

According to a second implementation of the first embodiment of the present disclosure, the discovery signal of the first-type user terminal 121 may be a second-type discovery signal, and the second-type discovery signal may be used for the first-type user terminal 111 to detect the first-type user terminal 121. In the second implementation, the discovery signal of the first-type user terminal 121 may also include the first-type discovery signal described above, so that a second-type user terminal (for example, the second-type user terminal 122, 123 or 124) may detect the first-type user terminal 121. That is, in the second implementation, two types of discovery signals (or may be referred to as two types of discovery signal sets) may be defined and/or (pre)configured, namely, a first-type discovery signal and a second-type discovery signal. With such definition and/or (pre)configuration, the first-type user terminal 111 may not detect the first-type discovery signal of the first-type user terminal 121 by muting its own first-type discovery signal, but detect the first-type user terminal 121 by detecting the second-type discovery signal of the first-type user terminal 121.

In the second implementation, a first-type discovery signal may be (pre)configured in a user terminal-common manner, or may be indicated to a user terminal in a user terminal-common manner. Alternatively, the first-type discovery signal may be (pre)configured in a user terminal-specific manner, or may be indicated to a user terminal in a user terminal-specific manner.

In addition, in the second implementation, a second-type discovery signal may be (pre)configured in a user terminal-specific manner, or may be indicated to a user terminal in a user terminal-specific manner.

In addition, in the second implementation, transmission information for a second-type discovery signal may be indicated in a first-type discovery signal. For example, the first-type discovery signal may carry information about transmission occasions of the second-type discovery signal.

A schematic diagram of the first-type discovery signal and the second-type discovery signal according to the second implementation will be described below with reference to FIG. 4. As shown in FIG. 4, the black box represents a first-type discovery signal common to user terminals, the light gray box represents a second-type discovery signal of the first-type user terminal 111, and the dark gray box represents a second-type discovery signal of the first-type user terminal 121.

According to a third implementation of the first embodiment of the present disclosure, the first-type user terminal 111 detecting the discovery signal of the first-type user terminal 121 may include detecting a dedicated signal of the first-type user terminal 121, where the dedicated signal includes at least information carried by the discovery signal of the first-type user terminal 121. In the third implementation, the first-type user terminal 121 may transmit the dedicated signal, so that the first-type user terminal 111 may detect the first-type user terminal 121 by decoding/sensing the dedicated signal.

In the third implementation, the dedicated signal of the first-type user terminal 121 may be transmitted through a Physical Sidelink Control Channel (PSCCH)/Physical Sidelink Share Channel (PSSCH). For example, the dedicated signal of the first-type user terminal 121 may be transmitted through PSCCH/PSSCH of a resource set associated with the first-type user terminal 121. The resource set associated with the first-type user terminal 121 mentioned herein may be determined by using a New Radio (NR) sidelike resource allocation mode, for example, by a base station-scheduling based resource allocation mode, a user terminal-autonomous-selection resource allocation mode, or a user terminal-scheduling based resource allocation mode.

Alternatively, in the third implementation, the dedicated signal of the first-type user terminal 121 may be transmitted to other user terminals by broadcasting. The other user terminals may include the first-type user terminal 111 and/or second-type user terminals (for example, the second-type user terminals 122, 123, 124).

In addition, in the third implementation, the dedicated signal of the first-type user terminal 121 may be generated periodically. For example, the dedicated signal of first-type user terminal 121 may be periodically generated per time granularity. The time granularity mentioned herein is similar to the time granularity described above, and will not be repeatedly described herein.

It should be appreciated that although only three implementations for the first-type user terminal 111 to acquire the detection information for the first-type user terminal 121 are described above, the present disclosure is not limited thereto. The present disclosure may also include any other implementations for the first-type user terminal 111 to acquire the detection information for the first-type user terminal 121.

After the first-type user terminal 111 acquires the detection information for the first-type user terminal 121 in step S201, in step S202, the first-type user terminal 111 determines whether to regroup the user terminal group according to the acquired detection information; and when it is determined to regroup the user terminal group in step S202, in step S203, the first-type user terminal 111 regroups the user terminal group.

For example, as described above, the detection information may be the measurement/sensing result of the first-type user terminal 111 for the first-type user terminal 121. Therefore, in step S202, the first-type user terminal 111 may determine whether to regroup the user terminal group according to a relationship between the measurement/sensing result of the first-type user terminal 111 for the first-type user terminal 121 and a predetermined threshold. For example, in step S202, the first-type user terminal 111 may determine whether the measurement/sensing result of the first-type user terminal 111 for the first-type user terminal 121 is greater than the predetermined threshold, and if so, the first-type user terminal 111 determines to regroup the user terminal group. Accordingly, in step S203, the first-type user terminal 111 may regroup the user terminal group. In addition, in step S202, if the first-type user terminal 111 determines that the measurement/sensing result of the first-type user terminal 111 for the first-type user terminal 121 is not greater than the predetermined threshold, then the first-type user terminal 111 may determine not to regroup the user terminal group. Accordingly, in step S203, the first-type user terminal 111 may not regroup the user terminal group.

In this case, when the first-type user terminal 111 regroups the user terminal group, the first-type user terminal 111 may further determine whether it can continue to serve as a first-type user terminal. For example, the first-type user terminal 111 may determine whether it can continue to serve as a first-type user terminal by whether it achieve a probability of serving as a first-type user terminal, by its back-off time for serving as a first-type user terminal, or by information interacted with other user terminals.

In addition, after the first-type user terminal 111 acquires the detection information for the first-type user terminal 121 in step S201, the method 200 may further include: the first-type user terminal 111 determining whether to reselect resources for the user terminal group at least according to the acquired detection information; and when it is determined to reselect resources for the user terminal group, reselecting resources for the user terminal group.

For example, the detection information may also be resource set information of the first-type user terminal 121. In this example, the first-type user terminal 111 may further acquire a resource reuse average distance associated with the resource set of the first-type user terminal 121. When a distance between the first-type user terminal 111 and the first-type user terminal 121 is greater than the average resource reuse distance, the first-type user terminal and the first-type user terminal 121 can reuse the resource set of the first-type user terminal 121; and when the distance between the first-type user terminal 111 and the first-type user terminal 1 121 is less than the resource reuse average distance, the first-type user terminal 111 and the first-type user terminal 121 cannot reuse the resource set of the first-type user terminal 121.

Therefore, the first-type user terminal 111 may determine whether to reselect resources for the user terminal group based on the resource set information of the first-type user terminal 121 and the average resource reuse distance associated with the resource set of the first-type user terminal 121. For example, the first-type user terminal 111 may determine whether the distance between the first-type user terminal 111 and the first-type user terminal 121 is less than the average resource reuse distance, and if so, the first-type user terminal 111 determines to reselect resources for the user terminal group. Accordingly, the first-type user terminal 111 may reselect resources for the user terminal group. In addition, if the first-type user terminal 111 determines that the distance between the first-type user terminal 111 and the first-type user terminal 121 is greater than the average resource reuse distance, the first-type user terminal 111 may determine not to reselect resources for the user terminal group. Accordingly, the first-type user terminal 111 may not reselect resources for the user terminal group.

In the first embodiment of the present disclosure, the first-type user terminal 111 may perform at least one of regrouping the user terminal group and reselecting resources for the user terminal group. When the first-type user terminal 111 performs both of regrouping the user terminal group and reselecting resources for the user terminal group, the first-type user terminal 111 may perform them simultaneously, or may perform the regrouping firstly and then reselect resources for the regrouped user terminal group.

With the first embodiment of the present disclosure, when user terminal groups using the same resources or resource set move closer, a first-type user terminal in a user terminal group may detect another first-type user terminal in another user terminal group, and determine whether to regroup the user terminal group and/or reselect resources for the user terminal group according to a detection result, so as to ensure that a plurality of adjacent user terminal groups use resources or resource sets orthogonal to each other, thereby avoiding interference between user terminal groups, improving communication quality, and increasing a resource reuse rate.

A method performed by a first-type user terminal according to a second embodiment of the present disclosure will be described below with reference to FIG. 5. FIG. 5 is a flowchart of a method 500 performed by a first-type user terminal according to the second embodiment of the present disclosure. As shown in FIG. 5, in step S501, a first-type user terminal acquires detection information for another first-type user terminal from a second-type user terminal, where the first-type user terminal is used to control the second-type user terminal, and the first-type user terminal and the second-type user terminal belong to one user terminal group. Hereinafter, the “first-type user terminal” being the “first-type user terminal 111” described above, and the “another first-type user terminal” being the “first-type user terminal 121” described above will be taken as an example to describe the second embodiment of the present disclosure.

In the second embodiment of the present disclosure, the first-type user terminal 111 acquiring detection information for the first-type user terminal 121 may include: the first-type user terminal 111 receiving the detection information from the second-type user terminal (for example, the second-type user terminal 112, 113 or 114), where the detection information is acquired by the second-type user terminal (for example, the second-type user terminal 112, 113 or 114) detecting a discovery signal of the first-type user terminal 121.

In this embodiment, the discovery signal may be any signal (or may also be referred to as signaling) used to detect the first-type user terminal 121. For example, the discovery signal may be a Sidelink Synchronization Signal (SLSS). As another example, the discovery signal may be a signal transmitted on a Physical Sidelink Broadcast Channel (PSBCH).

In addition, the discovery signal may carry auxiliary information, which may assist the first-type user terminal 111 to measure/sense the first-type user terminal 121 after detecting the first-type user terminal 121, to acquire the detection information. For example, the auxiliary information may assist the first-type user terminal 111 to measure/sense strength of a signal transmitted by the first-type user terminal 121 to acquire a measurement/sensing result. In this case, the measurement/sensing result may be the detection information of the first-type user terminal 111 for the first-type user terminal 121. In addition, the measurement/sensing result may be, for example, one or more of Reference Signal Receiving Power (RSRP), Received Signal Strength Indication (RSSI), Reference Signal Receiving Quality (RSRQ), Signal to Interference plus Noise Ratio (SINR), Signal to Noise Ratio (SNR) and the like.

The auxiliary information mentioned herein may be attribute information of the first-type user terminal 121. For example, the attribute information of the first-type user terminal 121 may include identification information of the first-type user terminal 121, for example, one or more of ID, Service Set Identifier (SSID), Radio Network Temporary Identity (RNTI) and the like of the first-type user terminal 121.

As another example, the attribute information of the first-type user terminal 121 may also include movement information of the first-type user terminal 121, for example, one or more of an average speed, a maximum speed and the like of the first-type user terminal 121.

As another example, the attribute information of the first-type user terminal 121 may also include location information of the first-type user terminal 121, for example, one or more of a geographic location (such as an absolute location or an area ID, etc.) of the first-type user terminal 121, a relative location between the first-type user terminal 121 and a proximity user terminal that does not belong to any user terminal group, an average distance between the first-type user terminal 121 and proximity user terminals that do not belong to any user terminal group, and the like. In the present disclosure, a proximity user terminal may be determined by the first-type user terminal 121 performing signal measurement on other user terminals. For example, the first-type user terminal 121 performs signal measurement on other user terminal to obtain a measurement result (for example, signal receiving quality), and when the measurement result is greater than a first threshold, the other user terminal may be the proximity communication device of the first-type user terminal 121. In addition, the proximity user terminal may also be determined according to locations of the first-type user terminal 121 and other user terminal. For example, when a linear distance between the other user terminal and the first-type user terminal 121 is less than a predetermined threshold, the other user terminal may be the proximity user terminal of the first-type user terminal 121.

As another example, the attribute information of the first-type user terminal 121 may also include a measurement/sensing result of the first-type user terminal 121 for a proximity user terminal that does not belong to any user terminal group. The measurement/sensing result may be a measurement result of the first-type user terminal 121 for strength of a signal received from the proximity user terminal that does not belong to any user terminal group, for example, one or more of RSRP, RSSI, RSRQ, SINR, SNR and the like.

As another example, the attribute information of the first-type user terminal 121 may also include information about the number of proximity user terminals that do not belong to any user terminal group, for example, the number of proximity user terminals that do not belong to any user terminal group during a predetermined period of time.

As another example, the attribute information of the first-type user terminal 121 may also include priority information for the first-type user terminal 121 to serve as a first-type user terminal. For example, a priority may be defined based on a determination manner of the first-type user terminal. For example, when the first-type user terminal is determined through high layer signaling, the priority for the first-type user terminal 121 to serve as a first-type user terminal may be set to 1; when the first-type user terminal is determined through a (pre)configuration, the priority for the first-type user terminal 121 to serve as a first-type user terminal may be set to 2; when the first-type user terminal is determined through an automatic selection, the priority for the first-type user terminal 121 to serve as a first-type user terminal may be set to 3.

As another example, the attribute information of the first-type user terminal 121 may also include class information of the first-type user terminal 121, for example, a class identifier of the first-type user terminal 121, such as a class identifier of the first-type user terminal 121 belonging to a bus, a truck, a car or the like.

It should be appreciated that although the above examples describe that the attribute information of the first-type user terminal 121 may include the identification information of the first-type user terminal 121, the movement information of the first-type user terminal 121, the location information of the first-type user terminal 121, the measurement/sensing result of the first-type user terminal 121 for a proximity user terminal that does not belong to any user terminal group, the information about the number of proximity user terminals that do not belong to any user terminal group, the priority information for serving as a first-type user terminal, and/or the class information of the first-type user terminal 121, the present disclosure is not limited thereto. According to other examples, the attribute information of the first-type user terminal 121 may further include any other attribute information of the first-type user terminal 121.

According to one example of the second embodiment, the second-type user terminal (for example, the second-type user terminal 112, 113 or 114) may report, to the first-type user terminal 111, its measurement information for the first-type user terminal 121 through low layer signaling such as physical layer signaling, Sidelink Control Information (SCI), and Downlink Control Information (DCI). Accordingly, the first-type user terminal 111 may acquire, from the second-type user terminal, the measurement information of the second-type user terminal for the first-type user terminal 121 through low layer signaling such as physical layer signaling, SCI, and DCI. As another example, the second-type user terminal may report, to the first-type user terminal 111, its measurement information for the first-type user terminal 121 through high layer signaling such as Radio Resource Control (RRC) signaling or Media Access Control (MAC) Control Elements (CEs). Accordingly, the first-type user terminal 111 may acquire, from the second-type user terminal, the measurement information of the second-type user terminal for the first-type user terminal 121 through high layer signaling such as RRC signaling or MAC CEs.

According to another example of the second embodiment, the second-type user terminal (for example, the second-type user terminal 112, 113 or 114) may report, to the first-type user terminal 111, its measurement information for the first-type user terminal 121 through a Physical Sidelink Control Channel (PSCCH)/Physical Sidelink Share Channel (PSSCH). In this case, resources used may be determined according to a sidelink resource allocation mechanism. Accordingly, the first-type user terminal 111 may acquire, from the second-type user terminal, the measurement information of the second-type user terminal for the first-type user terminal 121 through PSCCH/PSSCH.

In addition, according to one example of the second embodiment, the second-type user terminal (for example, the second-type user terminal 112, 113 or 114) may periodically report, to the first-type user terminal 111, its measurement information for the first-type user terminal 121. For example, the second-type user terminal may periodically report, to the first-type user terminal 111, its measurement information for the first-type user terminal 121 according to a time granularity. The time granularity mentioned herein may be a specific time period (in seconds or milliseconds), a Transmission Time Interval (TTI), a symbol, a time slot, a mini-slot, a subframe, a frame, a SLSS/PSBCH transmission occasion or the like. Accordingly, the first-type user terminal 111 may periodically acquire, from the second-type user terminal, the measurement information of the second-type user terminal for the first-type user terminal 121.

According to another example of the second embodiment, the second-type user terminal (for example, the second-type user terminal 112, 113 or 114) may trigger the second-type user terminal to report, to the first-type user terminal 111, its measurement information for the first-type user terminal 121 based on a specific event. The specific event may be, for example, that the measurement/sensing result of the second-type user terminal for the first-type user terminal 121 is greater than a predetermined threshold, or that the measurement/sensing result of the second-type user terminal for the first-type user terminal 121 is greater than a measurement/sensing result of the second-type user terminal for the first-type user terminal 111 (measuring/sensing of the second-type user terminal for the first-type user terminal 111 will be described below), or that the measurement/sensing result of the second-type user terminal for the first-type user terminal 121 is greater than the measurement/sensing result of the second-type user terminal for the first-type user terminal 111 by a predetermined value. The above-mentioned “predetermined threshold” and “predetermined value” may be defined by communication standard protocol specifications such as 3GPP and the like or (pre)configured, may be indicated by the first-type user terminal 111, or may be determined in any other manners.

In addition, before step S502, the method 500 may further include: the first-type user terminal 111 receiving, from the second-type user terminal, measurement information of the second-type user terminal for the first-type user terminal 111. For example, the second-type user terminal may detect the discovery signal of the first-type user terminal 111, and measure the first-type user terminal 111 according to the discovery signal of the first-type user terminal 111 to acquire the measurement information (for example, the measurement/sensing result), which, for example, may be one or more of RSRP, RSSI, RSRQ, SINR, SNR, and the like.

According to one example of the second embodiment, the second-type user terminal (for example, the second-type user terminal 112, 113 or 114) may report, to the first-type user terminal 111, its measurement information for the first-type user terminal 111 through low layer signaling such as physical layer signaling, SCI, and DCI. Accordingly, the first-type user terminal 111 may acquire, from the second-type user terminal, the measurement information of the second-type user terminal for the first-type user terminal 111 through low layer signaling such as physical layer signaling, SCI, and DCI. As another example, the second-type user terminal may report, to the first-type user terminal 111, its measurement information for the first-type user terminal 111 through high layer signaling such as RRC signaling or MAC CEs. Accordingly, the first-type user terminal 111 may acquire, from the second-type user terminal, the measurement information of the second-type user terminal for the first-type user terminal 111 through high layer signaling such as RRC signaling or MAC CEs.

According to another example of the second embodiment, the second-type user terminal (for example, the second-type user terminal 112, 113 or 114) may report, to the first-type user terminal 111, its measurement information for the first-type user terminal 111 through PSCCH/PSSCH. Accordingly, the first-type user terminal 111 may acquire, from the second-type user terminal, the measurement information of the second-type user terminal for the first-type user terminal 111 through PSCCH/PSSCH.

In addition, according to one example of the second embodiment, the second-type user terminal (for example, the second-type user terminal 112, 113 or 114) may periodically report, to the first-type user terminal 111, its measurement information for the first-type user terminal 111. For example, the second-type user terminal may periodically report, to the first-type user terminal 111, its measurement information for the first-type user terminal 111 according to a time granularity. The time granularity mentioned herein is similar to the time granularity described above, and will not be repeatedly described herein. Accordingly, the first-type user terminal 111 may periodically acquire, from the second-type user terminal, the measurement information of the second-type user terminal for the first-type user terminal 111.

Then, in step S502, the first-type user terminal 111 determines whether to regroup the user terminal group according to the acquired detection information; and when it is determined in step S502 to regroup the user terminal group, in step S503, the first-type user terminal 111 regroups the user terminal group.

For example, as described above, the detection information acquired by the first-type user terminal 111 may be the measurement/sensing result of the second-type user terminal (for example, the second-type user terminal 112, 113 or 114) for the first-type user terminal 121. In this example, the first-type user terminal 111 may determine whether to regroup the user terminal group according to a relationship between the measurement/sensing result of the second-type user terminal for the first-type user terminal 121 and a predetermined threshold. For example, when the measurement/sensing result of the second-type user terminal for the first-type user terminal 121 is greater than the predetermined threshold, in step S502, the first-type user terminal 111 determines to regroup the user terminal group. Accordingly, in step S503, the first-type user terminal 111 may regroup the user terminal group. In addition, if the measurement/sensing result of the second-type user terminal for the first-type user terminal 121 is less than the predetermined threshold, in step S502, the first-type user terminal 111 determines not to regroup the user terminal group. Accordingly, in step S503, the first-type user terminal 111 may not regroup the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to regroup the user terminal group according to a relationship between the measurement/sensing result of the second-type user terminal for the first-type user terminal 121 and the measurement/sensing result of the second-type user terminal for this first-type user terminal 111. For example, when the measurement/sensing result of the second-type user terminal for the first-type user terminal 121 is greater than the measurement/sensing result of the second-type user terminal for this first-type user terminal 111, in step S502, the first-type user terminal 111 determines to regroup the user terminal group. Accordingly, in step S503, the first-type user terminal 111 may regroup the user terminal group. In addition, if the measurement/sensing result of the second-type user terminal for the first-type user terminal 121 is less than the measurement/sensing result of the second-type user terminal for this first-type user terminal 111, in step S502, the first-type user terminal 111 determines not to regroup the user terminal group. Accordingly, in step S503, the first-type user terminal 111 may not regroup the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to regroup the user terminal group according to a relationship among the measurement/sensing result of the second-type user terminal for the first-type user terminal 121, the measurement/sensing result of the second-type user terminal for this first-type user terminal 111 and a predetermined value. For example, when the measurement/sensing result of the second-type user terminal for the first-type user terminal 121 is greater than the measurement/sensing result of the second-type user terminal for this first-type user terminal 111 by a predetermined value, in step S502, the first-type user terminal 111 determines to regroup the user terminal group. Accordingly, in step S503, the first-type user terminal 111 may regroup the user terminal group. In addition, if the measurement/sensing result of the second-type user terminal for the first-type user terminal 121 is not greater than the measurement/sensing result of the second-type user terminal for this first-type user terminal 111 by the predetermined value, in step S502, the first-type user terminal 111 determines not to regroup the user terminal group. Accordingly, in step S503, the first-type user terminal 111 may not regroup the user terminal group.

In addition, after the first-type user terminal 111 acquires the detection information for the first-type user terminal 121 in step S501, the method 500 may further include: the first-type user terminal 111 determining whether to reselect resources for the user terminal group at least according to the acquired detection information; and when it is determined to reselect resources for the user terminal group, reselecting resources for the user terminal group.

For example, as described above, the detection information acquired by the first-type user terminal 111 may be the measurement/sensing result of the second-type user terminal (for example, the second-type user terminal 112, 113 or 114) for the first-type user terminal 121. In this example, the first-type user terminal 111 may determine whether to reselect resources for the user terminal group according to a relationship between the measurement/sensing result of the second-type user terminal for the first-type user terminal 121 and a predetermined threshold. For example, when the measurement/sensing result of the second-type user terminal for the first-type user terminal 121 is greater than the predetermined threshold, the first-type user terminal 111 determines that it can reselect resources for the user terminal group. Accordingly, the first-type user terminal 111 may reselect resources for the user terminal group. In addition, if the measurement/sensing result of the second-type user terminal for the first-type user terminal 121 is less than the predetermined threshold, the first-type user terminal 111 determines not to reselect resources for the user terminal group. Accordingly, the first-type user terminal 111 may not reselect resources for the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to reselect resources for the user terminal group according to a relationship between the measurement/sensing result of the second-type user terminal for the first-type user terminal 121 and the measurement/sensing result of the second-type user terminal for this first-type user terminal 111. For example, when the measurement/sensing result of the second-type user terminal for the first-type user terminal 121 is greater than the measurement/sensing result of the second-type user terminal for this first-type user terminal 111, the first-type user terminal 111 determines that it can reselect resources for the user terminal group. Accordingly, the first-type user terminal 111 may reselect resources for the user terminal group. In addition, if the measurement/sensing result of the second-type user terminal for the first-type user terminal 121 is less than the measurement/sensing result of the second-type user terminal for this first-type user terminal 111, the first-type user terminal 111 determines not to reselect resources for the user terminal group. Accordingly, the first-type user terminal 111 may not reselect resources for the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to reselect resources for the user terminal group according to a relationship among the measurement/sensing result of the second-type user terminal for the first-type user terminal 121, the measurement/sensing result of the second-type user terminal for this first-type user terminal 111 and a predetermined value. For example, when the measurement/sensing result of the second-type user terminal for the first-type user terminal 121 is greater than the measurement/sensing result of the second-type user terminal for this first-type user terminal 111 by a predetermined value, the first-type user terminal 111 determines that it can reselect resources for the user terminal group. Accordingly, the first-type user terminal 111 may reselect resources for the user terminal group. In addition, if the measurement/sensing result of the second-type user terminal for the first-type user terminal 121 is not greater than the measurement/sensing result of the second-type user terminal for this first-type user terminal 111 by the predetermined value, the first-type user terminal 111 determines not to reselect resources for the user terminal group. Accordingly, the first-type user terminal 111 may not reselect resources for the user terminal group.

In the second embodiment of the present disclosure, the first-type user terminal 111 may perform at least one of regrouping the user terminal group and reselecting resources for the user terminal group. When the first-type user terminal 111 performs both of regrouping the user terminal group and reselecting resources for the user terminal group, the first-type user terminal 111 may perform them simultaneously, or may perform the regrouping firstly and then reselect resources for the regrouped user terminal group.

With the second embodiment of the present disclosure, when user terminal groups using the same resources or resource set move closer, a second-type user terminal in a user terminal group may detect a first-type user terminal in another user terminal group, and report a detection result to a first-type user terminal associated with itself, such that the first-type user terminal determines whether to regroup the user terminal group and/or reselect resources for the user terminal group according to the detection result, so as to ensure that a plurality of adjacent user terminal groups use resources or resource sets orthogonal to each other, thereby avoiding interference between user terminal groups, improving communication quality, and increasing a resource reuse rate.

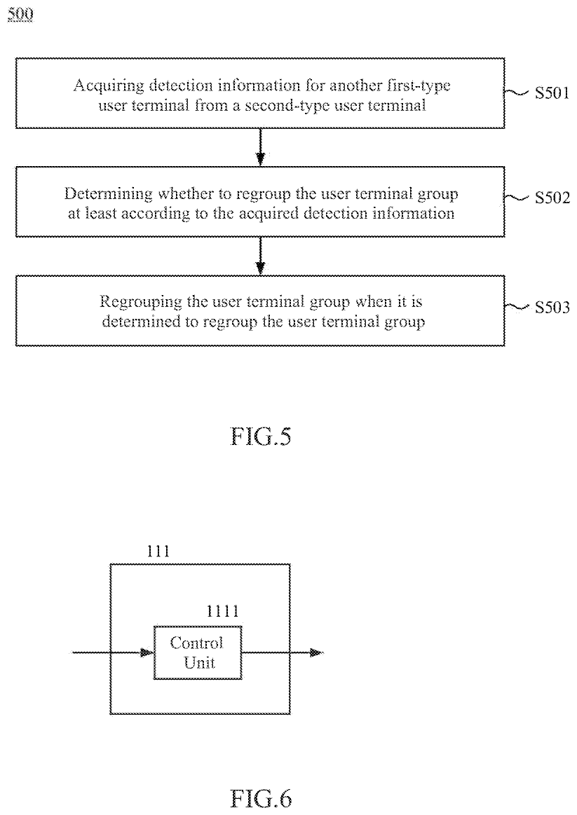

A first-type user terminal 111 according to the first embodiment of the present disclosure will be described below with reference to FIG. 6. FIG. 6 is a schematic structural diagram of the first-type user terminal 111 according to the first embodiment of the present disclosure. Since functions of the first-type user terminal 111 are the same as the details of the method described above with reference to FIG. 2, a detailed description of the same content is omitted herein for the sake of simplicity. As shown in FIG. 6, the first-type user terminal 111 includes: a control unit 1111 configured to acquire detection information for another first-type user terminal, where the first-type user terminal is used to control a second-type user terminal, and the first-type user terminal and the second-type user terminal belong to one user terminal group; determine whether to regroup the user terminal group at least according to the acquired detection information; and when it is determined to regroup the user terminal group, regroup the user terminal group. In addition to this unit, the first-type user terminal 111 may further include other components. However, since these components are not related to the content of the embodiments of the present disclosure, illustration and description thereof are omitted herein.

In the first embodiment of the present disclosure, the control unit 1111 acquiring detection information for the first-type user terminal 121 may include: the control unit 1111 detecting a discovery signal of the first-type user terminal 121 to acquire the detection information.

The discovery signal may be any signal (or may also be referred to as signaling) used to detect the first-type user terminal 121. For example, the discovery signal may be a Sidelink Synchronization Signal (SLSS). As another example, the discovery signal may be a signal transmitted on a Physical Sidelink Broadcast Channel (PSBCH).

In addition, the discovery signal may carry auxiliary information, which may assist the first-type user terminal 111 to measure/sense the first-type user terminal 121 after detecting the first-type user terminal 121, to acquire the detection information. For example, the auxiliary information may assist the first-type user terminal 111 to measure/sense strength of a signal transmitted by the first-type user terminal 121 to acquire a measurement/sensing result. In this case, the measurement/sensing result may be the detection information of the first-type user terminal 111 for the first-type user terminal 121. In addition, the measurement/sensing result may be, for example, one or more of Reference Signal Receiving Power (RSRP), Received Signal Strength Indication (RSSI), Reference Signal Receiving Quality (RSRQ), Signal to Interference plus Noise Ratio (SINR), Signal to Noise Ratio (SNR) and the like.

The auxiliary information mentioned herein may be attribute information of the first-type user terminal 121. For example, the attribute information of the first-type user terminal 121 may include identification information of the first-type user terminal 121, movement information of the first-type user terminal 121, location information of the first-type user terminal 121, a measurement/sensing result of the first-type user terminal 121 for a proximity user terminal that does not belong to any user terminal group, information about the number of proximity user terminals that do not belong to any user terminal group, priority information for serving as a first-type user terminal, and/or class information of the first-type user terminal 121, but the present disclosure is not limited thereto. According to other examples, the attribute information of the first-type user terminal 121 may further include any other attribute information of the first-type user terminal 121.

According to a first implementation of the first embodiment of the present disclosure, the discovery signal of the first-type user terminal 121 may be a first-type discovery signal, and the first-type discovery signal may be used for a second-type user terminal (for example, the second-type user terminal 122, 123 or 124) to detect the first-type user terminal 121.

In the first implementation, the control unit 1111 detecting a discovery signal of the first-type user terminal 121 may include: the control unit 1111 detecting the first-type discovery signal of the first-type user terminal 121 when muting a first-type discovery signal of the first-type user terminal 111. Due to a half-duplex communication mode of the user terminals, the user terminals can only perform one of transmitting operation and receiving operation at a certain moment. Therefore, the first-type user terminal 111 may not transmit its own first-type discovery signal (that is, mute its own first-type discovery signal) at certain moments, so as to be able to receive the first-type discovery signal of the first-type user terminal 121 at these moments, to detect the first-type discovery signal of the first-type user terminal 121, thereby realizing detection of the first-type user terminal 121.

According to a first example of the first implementation, the control unit 1111 may further determine a probability of muting the first-type discovery signal of the first-type user terminal 111 at a transmission occasion of the first-type discovery signal of the first-type user terminal 111. As described above, the discovery signal may be SLSS/PSBCH. Therefore, the transmission occasion of the first-type discovery signal of the first-type user terminal 111 may be an SLSS/PSBCH transmission occasion.

In the first example, the probability of muting the first-type discovery signal of the first-type user terminal 111 at the transmission occasion of the first-type discovery signal of the first-type user terminal 111 may be, for example, a probability defined by communication standard protocol specifications such as 3GPP and the like. For example, the probability may be 10%, 20%, 50% or the like.

As another example, the probability of muting the first-type discovery signal of the first-type user terminal 111 at the transmission occasion of the first-type discovery signal of the first-type user terminal 111 may also be a (pre)configured probability. For example, the probability may be written into a SIM card of the user terminal, or may be a probability configured by a base station after the user terminal accesses the base station. For example, the probability may be 10%, 20% or 50%.

As another example, the probability of muting the first-type discovery signal of the first-type user terminal 111 at the transmission occasion of the first-type discovery signal of the first-type user terminal 111 may also be a probability selected from a probability range defined by communication standard protocol specifications such as 3GPP and the like or a (pre)configured probability range. For example, the first-type user terminal 111 may randomly select a probability from the probability range as the probability of muting the first-type discovery signal of the first-type user terminal 111. For example, the probability range may be 10%˜50%, and the first-type user terminal 111 may select 40% from the probability range as the probability of muting the first-type discovery signal of the first-type user terminal 111 at the transmission occasion of the first-type discovery signal of the first-type user terminal 111.

As another example, the probability of muting the first-type discovery signal of the first-type user terminal 111 at the transmission occasion of the first-type discovery signal of the first-type user terminal 111 may also be determined based on a preset rule. The preset rule may be a preset function, such as a utility function. An input of the utility function may be the attribute information of the first-type user terminal 111, and an output of the utility function may be associated with the probability.

In addition, in the first example, determining a probability of muting the first-type discovery signal of the first-type user terminal 111 at a transmission occasion of the first-type discovery signal of the first-type user terminal 111 may be determining a probability of muting the first-type discovery signal of the first-type user terminal 111 at each transmission occasion of the first-type discovery signal of the first-type user terminal 111.

In this case, the probability of muting the first-type discovery signal of the first-type user terminal 111 at each transmission occasion of the first-type discovery signal of the first-type user terminal 111 may be the same. For example, the probability of muting the first-type discovery signal of the first-type user terminal 111 at each transmission occasion of the first-type discovery signal of the first-type user terminal 111 may be 20%.

In addition, in this case, the probability of muting the first-type discovery signal of the first-type user terminal 111 at each transmission occasion of the first-type discovery signal of the first-type user terminal 111 may be different. For example, a probability of muting the first-type discovery signal of the first-type user terminal 111 at a first transmission occasion of the first-type discovery signal of the first-type user terminal 111 may be 10%; a probability of muting the first-type discovery signal of the first-type user terminal 111 at a second transmission occasion of the first-type discovery signal of the first-type user terminal 111 may be 80%; a probability of muting the first-type discovery signal of the first-type user terminal 111 at a third transmission occasion of the first-type discovery signal of the first-type user terminal 111 may be 10%, and so on.

Alternatively, determining a probability of muting the first-type discovery signal of the first-type user terminal 111 at a transmission occasion of the first-type discovery signal of the first-type user terminal 111 may be determining a probability of muting the first-type discovery signal of the first-type user terminal 111 at one or more specific transmission occasions of the first-type discovery signal of the first-type user terminal 111. For example, only a probability of muting the first-type discovery signal of the first-type user terminal 111 at the second transmission occasion of the first-type discovery signal of the first-type user terminal 111 may be determined, for example, 80%.

In addition, in the first example, after determining the probability of muting the first-type discovery signal of the first-type user terminal 111 at the transmission occasion of the first-type discovery signal of the first-type user terminal 111, the control unit 1111 may further mute the first-type discovery signal of the first-type user terminal 111 according to the probability at the transmission occasion.

The SLSS/PSBCH transmission occasion described above may correspond to a plurality of resources, and SLSS/PSBCH may be transmitted on each of the plurality of resources. Therefore, if the first-type discovery signal of the first-type user terminal 111 is not muted, the first-type discovery signal of the first-type user terminal 111 may be transmitted at the SLSS/PSBCH transmission occasion and on each of the plurality of resources corresponding to the SLSS/PSBCH transmission occasion. However, in the first example, in order to detect the first-type discovery signal of the first-type user terminal 121, the first-type user terminal 111 may mute the first-type discovery signal of the first-type user terminal 111 at the transmission occasion and on specific resources of the plurality of resources corresponding to the transmission occasion. For example, in the first example, the first-type user terminal 111 may mute the first-type discovery signal of the first-type user terminal 111 according to the probability at the transmission occasion and on the specific resources of the plurality of resources corresponding to the transmission occasion.

In addition, in the first example, the first-type user terminal 111 can only mute the first-type discovery signal of the first-type user terminal 111 on the specific resources of the plurality of resources corresponding to the transmission occasion, rather than mute the first-type discovery signal of the first-type user terminal 111 on each resource of the plurality of resources corresponding to the transmission occasion. This ensures that a second-type user terminal (for example, the second-type user terminal 112, 113 or 114) can detect the first-type user terminal 111, and can receive, from the first-type user terminal 111, control or scheduling signaling of the first-type user terminal 111 to the second-type user terminal, so as to accept the control or scheduling of the first-type user terminal 111.

According to a second example of the first implementation, the control unit 1111 may further determine a muting pattern for a transmission occasion of the first-type discovery signal of the first-type user terminal 111. The muting pattern may be represented by a bit sequence, for example, where a length of the bit sequence may be equal to the number of the plurality of resources corresponding to the transmission occasion, a plurality of bits in the bit sequence respectively correspond to the plurality of resources, and values of the plurality of bits indicate whether to mute the first-type discovery signal on the plurality of resources. For example, when a value of a bit is 1, the first-type discovery signal is not muted on one of the plurality of resources corresponding to the bit; and when the value of the bit is 0, the first-type discovery signal is muted on one of the plurality of resources corresponding to the bit.

In the second example, for example, the muting pattern may be a bit sequence defined by communication standard protocol specifications such as 3GPP and the like. For example, the bit sequence may be [10101].

As another example, the muting pattern may also be a (pre)configured bit sequence. For example, the bit sequence may be written into a SIM card of a user terminal, or may be a bit sequence configured by a base station after the user terminal accesses the base station. For example, the bit sequence may be [10101].

As another example, the muting pattern may also be a bit sequence selected from candidate bit sequences defined by communication standard protocol specifications such as 3GPP and the like or (pre)configured candidate bit sequences. For example, the first-type user terminal 111 may randomly select a bit sequence from the candidate bit sequences as the muting pattern for muting the first-type discovery signal of the first-type user terminal 111. For example, the candidate bit sequences may include [10101], [11101], [10111] and so on, and the firs-type user terminal 111 may select [10101] from the candidate bit sequences as the muting pattern for muting the first-type discovery signal of the first-type user terminal 111 at the transmission occasion of the first-type discovery signal of the first-type user terminal 111.

As another example, the muting pattern may also be determined based on a preset rule. The preset rule may be a preset function, such as a utility function. An input of the utility function may be the attribute information of the first-type user terminal 111, and an output of the utility function may be associated with the muting pattern.

In addition, the length of the bit sequence as the muting pattern may be defined by, for example, communication standard protocol specifications such as 3GPP and the like. As another example, the length of the bit sequence as the muting pattern may be (pre)configured. As another example, the length of the bit sequence as the muting pattern may be selected from a range of bit sequence lengths defined by communication standard protocol specifications such as 3GPP and the like, or a (pre)configured range of bit sequence lengths. As another example, the length of the bit sequence as the muting pattern may be determined based on a preset rule. However, the present disclosure is not limited thereto, and the present disclosure may further include any other methods for determining the length.

In addition, in the second example, determining a muting pattern for a transmission occasion of the first-type discovery signal of the first-type user terminal 111 may be determining a muting pattern for each transmission occasion of the first-type discovery signal of the first-type user terminal 111.

In this case, the muting pattern for each transmission occasion of the first-type discovery signal of the first-type user terminal 111 may be the same. For example, the muting pattern for each transmission occasion of the first-type discovery signal of the first-type user terminal 111 may be [10101].

In addition, in this case, the muting pattern for each transmission occasion of the first-type discovery signal of the first-type user terminal 111 may be different. For example, a muting pattern for a first transmission occasion of the first-type discovery signal of the first-type user terminal 111 may be [10101]; a muting pattern for a second transmission occasion of the first-type discovery signal of the first-type user terminal 111 may be [11101]; a muting pattern for a third transmission occasion of the first-type discovery signal of the first-type user terminal 111 may be [10111], and so on.

Alternatively, in the second example, determining a muting pattern for a transmission occasion of the first-type discovery signal of the first-type user terminal 111 may be determining a muting pattern for one or more specific transmission occasions of the first-type discovery signal of the first-type user terminal 111.

In addition, in the second example, determining a muting pattern for a transmission occasion of the first-type discovery signal of the first-type user terminal 111 may be determining one or more common muting patterns for all first-type user terminals 111. When there is one common muting pattern, the muting pattern for the transmission occasion of the first-type discovery signal of the first-type user terminal 111 may be the common muting pattern. When there are a plurality of common muting patterns, the first-type user terminal 111 may select one of the plurality of common muting patterns as the muting pattern for the transmission occasion of the first-type discovery signal of the first-type user terminal 111. For example, the first-type user terminal 111 may randomly select one of the plurality of common muting patterns as the muting pattern for the transmission occasion of the first-type discovery signal of the first-type user terminal 111. As another example, the first-type user terminal 111 may select, based on the attribute information of the first-type user terminal 111, one of the plurality of common muting patterns as the muting pattern for the transmission occasion of the first-type discovery signal of the first-type user terminal 111.

Alternatively, in the second example, determining a muting pattern for a transmission occasion of the first-type discovery signal of the first-type user terminal 111 may be determining a dedicated muting pattern for the first-type user terminal 111.

In addition, in the second example, determining a muting pattern for a transmission occasion of the first-type discovery signal of the first-type user terminal 111 may be periodically determining a muting pattern for a transmission occasion of the first-type discovery signal of the first-type user terminal 111.

Alternatively, in the second example, determining a muting pattern for a transmission occasion of the first-type discovery signal of the first-type user terminal 111 may be: the first-type user terminal 111 being triggered by a specific event to re-determine a muting pattern for the transmission occasion of the first-type discovery signal of the first-type user terminal 111. For example, the specific event may be that the number of times that the first-type user terminal 111 continuously uses a same muting pattern is greater than or equal to a predetermined threshold. That is, after using a same muting pattern multiple times, the first-type user terminal 111 may change the muting pattern may. The value of the predetermined threshold mentioned herein may be defined by communication standard protocol specifications such as 3GPP and the like or (pre) configured, or may also be determined in any other manners.

In addition, in the second example, after determining the muting pattern for a transmission occasion of the first-type discovery signal of the first-type user terminal 111, the control unit 111 may further mute the first-type discovery signal of the first-type user terminal 111 at the transmission occasion according to the muting pattern. For example, as described above, the muting pattern may indicate whether to mute the first-type discovery signal on the plurality of resources corresponding to the transmission occasion. Therefore, the control unit 111 may determine, according to the muting pattern, whether to mute the first-type discovery signal of the first-type user terminal 111 on each of the plurality of resources corresponding to the transmission occasion; and mute the first-type discovery signal of the first-type user terminal according to a determination result.

According to a second implementation of the first embodiment of the present disclosure, the discovery signal of the first-type user terminal 121 may be a second-type discovery signal, and the second-type discovery signal may be used for the first-type user terminal 111 to detect the first-type user terminal 121. In the second implementation, the discovery signal of the first-type user terminal 121 may also include the first-type discovery signal described above, so that a second-type user terminal (for example, the second-type user terminal 122, 123 or 124) may detect the first-type user terminal 121. That is, in the second implementation, two types of discovery signals (or may be referred to as two types of discovery signal sets) may be defined and/or (pre)configured, namely, a first-type discovery signal and a second-type discovery signal. With such definition and/or (pre)configuration, the first-type user terminal 111 may not detect the first-type discovery signal of the first-type user terminal 121 by muting its own first-type discovery signal, but detect the first-type user terminal 121 by detecting the second-type discovery signal of the first-type user terminal 121.

In the second implementation, a first-type discovery signal may be (pre)configured in a user terminal-common manner, or may be indicated to a user terminal in a user terminal-common manner. Alternatively, the first-type discovery signal may be (pre)configured in a user terminal-specific manner, or may be indicated to a user terminal in a user terminal-specific manner.

In addition, in the second implementation, a second-type discovery signal may be (pre)configured in a user terminal-specific manner, or may be indicated to a user terminal in a user terminal-specific manner.

In addition, in the second implementation, transmission information for a second-type discovery signal may be indicated in a first-type discovery signal. For example, the first-type discovery signal may carry information about transmission occasions of the second-type discovery signal.

According to a third implementation of the first embodiment of the present disclosure, the control unit 1111 may further include detecting a dedicated signal of the first-type user terminal 121, where the dedicated signal includes at least information carried by the discovery signal of the first-type user terminal 121. In the third implementation, the first-type user terminal 121 may transmit the dedicated signal, so that the first-type user terminal 111 may detect the first-type user terminal 121 by decoding/sensing the dedicated signal.

In the third implementation, the dedicated signal of the first-type user terminal 121 may be transmitted through a Physical Sidelink Control Channel (PSCCH)/Physical Sidelink Share Channel (PSSCH). For example, the dedicated signal of the first-type user terminal 121 may be transmitted through PSCCH/PSSCH of a resource set associated with the first-type user terminal 121. The resource set associated with the first-type user terminal 121 mentioned herein may be determined by using a New Radio (NR) sidelike resource allocation mode, for example, by a base station-scheduling based resource allocation mode, a user terminal-autonomous-selection resource allocation mode, or a user terminal-scheduling based resource allocation mode.

Alternatively, in the third implementation, the dedicated signal of the first-type user terminal 121 may be transmitted to other user terminals by broadcasting. The other user terminals may include the first-type user terminal 111 and/or second-type user terminals (for example, the second-type user terminals 122, 123, 124).

In addition, in the third implementation, the dedicated signal of the first-type user terminal 121 may be generated periodically. For example, the dedicated signal of first-type user terminal 121 may be periodically generated per time granularity. The time granularity mentioned herein is similar to the time granularity described above, and will not be repeatedly described herein.

After acquiring the detection information for the first-type user terminal 121, the control unit 1111 determines whether to regroup the user terminal group according to the acquired detection information; and when it is determined to regroup the user terminal group, regroups the user terminal group.

For example, as described above, the detection information may be the measurement/sensing result of the first-type user terminal 111 for the first-type user terminal 121. Therefore, the control unit 1111 may determine whether to regroup the user terminal group according to a relationship between the measurement/sensing result of the first-type user terminal 111 for the first-type user terminal 121 and a predetermined threshold. For example, the control unit 1111 may determine whether the measurement/sensing result of the first-type user terminal 111 for the first-type user terminal 121 is greater than the predetermined threshold, and if so, the control unit 1111 determines to regroup the user terminal group. Accordingly, the control unit 1111 may regroup the user terminal group. In addition, if the control unit 1111 determines that the measurement/sensing result of the first-type user terminal 111 for the first-type user terminal 121 is not greater than the predetermined threshold, then the control unit 1111 may determine not to regroup the user terminal group. Accordingly, the control unit 1111 may not regroup the user terminal group.

In addition, after the control unit 1111 acquires the detection information for the first-type user terminal 121, the control unit 1111 may further determine whether to reselect resources for the user terminal group at least according to the acquired detection information; and when it is determined to reselect resources for the user terminal group, reselect resources for the user terminal group.

For example, the detection information may also be resource set information of the first-type user terminal 121. In this example, the control unit 1111 may further acquire a resource reuse average distance associated with the resource set of the first-type user terminal 121. When a distance between the first-type user terminal 111 and the first-type user terminal 121 is greater than the average resource reuse distance, the first-type user terminal and the first-type user terminal 121 can reuse the resource set of the first-type user terminal 121; and when the distance between the first-type user terminal 111 and the first-type user terminal 1 121 is less than the resource reuse average distance, the first-type user terminal 111 and the first-type user terminal 121 cannot reuse the resource set of the first-type user terminal 121.

Therefore, the first-type user terminal 111 may determine whether to reselect resources for the user terminal group based on the resource set information of the first-type user terminal 121 and the average resource reuse distance associated with the resource set of the first-type user terminal 121. For example, the control unit 1111 may determine whether the distance between the first-type user terminal 111 and the first-type user terminal 121 is less than the average resource reuse distance, and if so, the control unit 1111 determines to reselect resources for the user terminal group. Accordingly, the control unit 1111 may reselect resources for the user terminal group. In addition, if the control unit 1111 determines that the distance between the first-type user terminal 111 and the first-type user terminal 121 is greater than the average resource reuse distance, the control unit 1111 may determine not to reselect resources for the user terminal group. Accordingly, the control unit 1111 may not reselect resources for the user terminal group.

In the first embodiment of the present disclosure, the control unit 1111 may perform at least one of regrouping the user terminal group and reselecting resources for the user terminal group. When the control unit 1111 performs both of regrouping the user terminal group and reselecting resources for the user terminal group, the control unit 1111 may perform them simultaneously, or may perform the regrouping firstly and then reselect resources for the regrouped user terminal group.

With the first-type user terminal of the first embodiment of the present disclosure, when user terminal groups using the same resources or resource set move closer, a first-type user terminal in a user terminal group may detect another first-type user terminal in another user terminal group, and determine whether to regroup the user terminal group and/or reselect resources for the user terminal group according to a detection result, so as to ensure that a plurality of adjacent user terminal groups use resources or resource sets orthogonal to each other, thereby avoiding interference between user terminal groups, improving communication quality, and increasing a resource reuse rate.

A first-type user terminal 111 according to the second embodiment of the present disclosure will be described below with reference to FIG. 7. FIG. 7 is a schematic structural diagram of the first-type user terminal 111 according to the second embodiment of the present disclosure. Since functions of the first-type user terminal 111 are the same as the details of the method described above with reference to FIG. 5, a detailed description of the same content is omitted herein for the sake of simplicity. As shown in FIG. 7, the first-type user terminal 111 includes: a control unit 1111 configured to acquire detection information for another first-type user terminal, where the first-type user terminal is used to control a second-type user terminal, and the first-type user terminal and the second-type user terminal belong to one user terminal group; determine whether to regroup the user terminal group at least according to the acquired detection information; and when it is determined to regroup the user terminal group, regroup the user terminal group. In addition to this unit, the first-type user terminal 111 may further include other components. However, since these components are not related to the content of the embodiments of the present disclosure, illustration and description thereof are omitted herein.

In the second embodiment of the present disclosure, the control unit 1111 acquiring detection information for the first-type user terminal 121 may include: the control unit 1111 receiving the detection information from the second-type user terminal (for example, the second-type user terminal 112, 113 or 114), where the detection information is acquired by the second-type user terminal (for example, the second-type user terminal 112, 113 or 114) detecting a discovery signal of the first-type user terminal 121.

In this embodiment, the discovery signal may be any signal (or may also be referred to as signaling) used to detect the first-type user terminal 121. For example, the discovery signal may be a Sidelink Synchronization Signal (SLSS). As another example, the discovery signal may be a signal transmitted on a Physical Sidelink Broadcast Channel (PSBCH).

In addition, the discovery signal may carry auxiliary information, which may assist the first-type user terminal 111 to measure/sense the first-type user terminal 121 after detecting the first-type user terminal 121, to acquire the detection information. For example, the auxiliary information may assist the first-type user terminal 111 to measure/sense strength of a signal transmitted by the first-type user terminal 121 to acquire the measurement/sensing result. In this case, the measurement/sensing result may be the detection information of the first-type user terminal 111 for the first-type user terminal 121. In addition, the measurement/sensing result may be, for example, one or more of Reference Signal Receiving Power (RSRP), Received Signal Strength Indication (RSSI), Reference Signal Receiving Quality (RSRQ), Signal to Interference plus Noise Ratio (SINR), Signal to Noise Ratio (SNR) and the like.

The auxiliary information mentioned herein may be attribute information of the first-type user terminal 121. For example, the attribute information of the first-type user terminal 121 may include identification information of the first-type user terminal 121, movement information of the first-type user terminal 121, location information of the first-type user terminal 121, a measurement/sensing result of the first-type user terminal 121 for a proximity user terminal that does not belong to any user terminal group, information about the number of proximity user terminals that do not belong to any user terminal group, priority information for serving as a first-type user terminal, and/or class information of the first-type user terminal 121, but the present disclosure is not limited thereto. According to other examples, the attribute information of the first-type user terminal 121 may further include any other attribute information of the first-type user terminal 121.

According to one example of the second embodiment, the second-type user terminal (for example, the second-type user terminal 112, 113 or 114) may report, to the first-type user terminal 111, its measurement information for the first-type user terminal 121 through low layer signaling such as physical layer signaling, Sidelink Control Information (SCI), and Downlink Control Information (DCI). Accordingly, the first-type user terminal 111 may acquire, from the second-type user terminal, the measurement information of the second-type user terminal for the first-type user terminal 121 through low layer signaling such as physical layer signaling, SCI, and DCI. As another example, the second-type user terminal may report, to the first-type user terminal 111, its measurement information for the first-type user terminal 121 through high layer signaling such as Radio Resource Control (RRC) signaling or Media Access Control (MAC) Control Elements (CEs). Accordingly, the control unit 1111 may acquire, from the second-type user terminal, the measurement information of the second-type user terminal for the first-type user terminal 121 through high layer signaling such as RRC signaling or MAC CEs.

According to another example of the second embodiment, the second-type user terminal (for example, the second-type user terminal 112, 113 or 114) may report, to the first-type user terminal 111, its measurement information for the first-type user terminal 121 through a Physical Sidelink Control Channel (PSCCH)/Physical Sidelink Share Channel (PSSCH). In this case, resources used may be determined according to a sidelink resource allocation mechanism. Accordingly, the control unit 1111 may acquire, from the second-type user terminal, the measurement information of the second-type user terminal for the first-type user terminal 121 through PSCCH/PSSCH.

In addition, according to one example of the second embodiment, the second-type user terminal (for example, the second-type user terminal 112, 113 or 114) may periodically report, to the first-type user terminal 111, its measurement information for the first-type user terminal 121. For example, the second-type user terminal may periodically report, to the first-type user terminal 111, its measurement information for the first-type user terminal 121 according to a time granularity. The time granularity mentioned herein may be a specific time period (in seconds or milliseconds), a Transmission Time Interval (TTI), a symbol, a time slot, a mini-slot, a subframe, a frame, a SLSS/PSBCH transmission occasion or the like. Accordingly, the control unit 1111 may periodically acquire, from the second-type user terminal, the measurement information of the second-type user terminal for the first-type user terminal 121.

According to another example of the second embodiment, the second-type user terminal (for example, the second-type user terminal 112, 113 or 114) may trigger the second-type user terminal to report, to the first-type user terminal 111, its measurement information for the first-type user terminal 121 based on a specific event. The specific event may be, for example, that the measurement/sensing result of the second-type user terminal for the first-type user terminal 121 is greater than a predetermined threshold, or that the measurement/sensing result of the second-type user terminal for the first-type user terminal 121 is greater than a measurement/sensing result of the second-type user terminal for the first-type user terminal 111 (measuring/sensing of the second-type user terminal for the first-type user terminal 111 will be described below), or that the measurement/sensing result of the second-type user terminal for the first-type user terminal 121 is greater than the measurement/sensing result of the second-type user terminal for the first-type user terminal 111 by a predetermined value. The above-mentioned “predetermined threshold” and “predetermined value” may be defined by communication standard protocol specifications such as 3GPP and the like or (pre)configured, may be indicated by the first-type user terminal 111, or may be determined in any other manners.

In addition, the first-type user terminal 111 may further include: a receiving unit 1112 configured to receive, from the second-type user terminal, measurement information of the second-type user terminal for the first-type user terminal 111. For example, the second-type user terminal may detect the discovery signal of the first-type user terminal 111, and measure the first-type user terminal 111 according to the discovery signal of the first-type user terminal 111 to acquire the measurement information (for example, the measurement/sensing result), which, for example, may be one or more of RSRP, RSSI, RSRQ, SINR, SNR, and the like.

According to one example of the second embodiment, the second-type user terminal (for example, the second-type user terminal 112, 113 or 114) may report, to the first-type user terminal 111, its measurement information for the first-type user terminal 111 through low layer signaling such as physical layer signaling, SCI, and DCI. Accordingly, the receiving unit 1112 may acquire, from the second-type user terminal, the measurement information of the second-type user terminal for the first-type user terminal 111 through low layer signaling such as physical layer signaling, SCI, and DCI. As another example, the second-type user terminal may report, to the first-type user terminal 111, its measurement information for the first-type user terminal 111 through high layer signaling such as RRC signaling or MAC CEs. Accordingly, the receiving unit 1112 may acquire, from the second-type user terminal, the measurement information of the second-type user terminal for the first-type user terminal 111 through high layer signaling such as RRC signaling or MAC CEs.

According to another example of the second embodiment, the second-type user terminal (for example, the second-type user terminal 112, 113 or 114) may report, to the first-type user terminal 111, its measurement information for the first-type user terminal 111 through PSCCH/PSSCH. Accordingly, the receiving unit 1112 may acquire, from the second-type user terminal, the measurement information of the second-type user terminal for the first-type user terminal 111 through PSCCH/PSSCH.

In addition, according to one example of the second embodiment, the second-type user terminal (for example, the second-type user terminal 112, 113 or 114) may periodically report, to the first-type user terminal 111, its measurement information for the first-type user terminal 111. For example, the second-type user terminal may periodically report, to the first-type user terminal 111, its measurement information for the first-type user terminal 111 according to a time granularity. The time granularity mentioned herein is similar to the time granularity described above, and will not be repeatedly described herein. Accordingly, the receiving unit 1112 may periodically acquire, from the second-type user terminal, the measurement information of the second-type user terminal for the first-type user terminal 111.

Then, the control unit 1111 determines whether to regroup the user terminal group according to the acquired detection information; and when it is determined to regroup the user terminal group, the first-type user terminal 111 regroups the user terminal group.

For example, as described above, the detection information acquired by the first-type user terminal 111 may be the measurement/sensing result of the second-type user terminal (for example, the second-type user terminal 112, 113 or 114) for the first-type user terminal 121. In this example, the first-type user terminal 111 may determine whether to regroup the user terminal group according to a relationship between the measurement/sensing result of the second-type user terminal for the first-type user terminal 121 and a predetermined threshold. For example, when the measurement/sensing result of the second-type user terminal for the first-type user terminal 121 is greater than the predetermined threshold, the control unit 1111 determines to regroup the user terminal group. Accordingly, the control unit 1111 may regroup the user terminal group. In addition, if the measurement/sensing result of the second-type user terminal for the first-type user terminal 121 is less than the predetermined threshold, the control unit 1111 determines not to regroup the user terminal group. Accordingly, the control unit 1111 may not regroup the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to regroup the user terminal group according to a relationship between the measurement/sensing result of the second-type user terminal for the first-type user terminal 121 and the measurement/sensing result of the second-type user terminal for this first-type user terminal 111. For example, when the measurement/sensing result of the second-type user terminal for the first-type user terminal 121 is greater than the measurement/sensing result of the second-type user terminal for this first-type user terminal 111, the control unit 1111 determines to regroup the user terminal group. Accordingly, the control unit 1111 may regroup the user terminal group. In addition, if the measurement/sensing result of the second-type user terminal for the first-type user terminal 121 is less than the measurement/sensing result of the second-type user terminal for this first-type user terminal 111, the control unit 1111 determines not to regroup the user terminal group. Accordingly, the control unit 1111 may not regroup the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to regroup the user terminal group according to a relationship among the measurement/sensing result of the second-type user terminal for the first-type user terminal 121, the measurement/sensing result of the second-type user terminal for this first-type user terminal 111 and a predetermined value. For example, when the measurement/sensing result of the second-type user terminal for the first-type user terminal 121 is greater than the measurement/sensing result of the second-type user terminal for this first-type user terminal 111 by a predetermined value, the control unit 1111 determines to regroup the user terminal group. Accordingly, the control unit 1111 may regroup the user terminal group. In addition, if the measurement/sensing result of the second-type user terminal for the first-type user terminal 121 is not greater than the measurement/sensing result of the second-type user terminal for this first-type user terminal 111 by the predetermined value, the control unit 1111 determines not to regroup the user terminal group. Accordingly, the control unit 1111 may not regroup the user terminal group.

In addition, after the control unit 1111 acquires the detection information for the first-type user terminal 121, the control unit 1111 may further determine whether to reselect resources for the user terminal group at least according to the acquired detection information; and when it is determined to reselect resources for the user terminal group, reselect resources for the user terminal group.

For example, as described above, the detection information acquired by the first-type user terminal 111 may be the measurement/sensing result of the second-type user terminal (for example, the second-type user terminal 112, 113 or 114) for the first-type user terminal 121. In this example, the first-type user terminal 111 may determine whether to reselect resources for the user terminal group according to a relationship between the measurement/sensing result of the second-type user terminal for the first-type user terminal 121 and a predetermined threshold. For example, when the measurement/sensing result of the second-type user terminal for the first-type user terminal 121 is greater than the predetermined threshold, the control unit 1111 determines that it can reselect resources for the user terminal group. Accordingly, the control unit 1111 may reselect resources for the user terminal group. In addition, if the measurement/sensing result of the second-type user terminal for the first-type user terminal 121 is less than the predetermined threshold, the control unit 1111 determines not to reselect resources for the user terminal group. Accordingly, the control unit 1111 may not reselect resources for the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to reselect resources for the user terminal group according to a relationship between the measurement/sensing result of the second-type user terminal for the first-type user terminal 121 and the measurement/sensing result of the second-type user terminal for this first-type user terminal 111. For example, when the measurement/sensing result of the second-type user terminal for the first-type user terminal 121 is greater than the measurement/sensing result of the second-type user terminal for this first-type user terminal 111, the control unit 1111 determines that it can reselect resources for the user terminal group. Accordingly, the control unit 1111 may reselect resources for the user terminal group. In addition, if the measurement/sensing result of the second-type user terminal for the first-type user terminal 121 is less than the measurement/sensing result of the second-type user terminal for this first-type user terminal 111, the control unit 1111 determines not to reselect resources for the user terminal group. Accordingly, the control unit 1111 may not reselect resources for the user terminal group.

As another example, as described above, the detection information acquired by the first-type user terminal 111 may be the measurement/sensing result of the second-type user terminal (for example, the second-type user terminal 112, 113 or 114) for the first-type user terminal 121, and the measurement/sensing result of the second-type user terminal (for example, the second-type user terminal 112, 113 or 114) for this first-type user terminal 111. In this example, the first-type user terminal 111 may determine whether to reselect resources for the user terminal group according to a relationship among the measurement/sensing result of the second-type user terminal for the first-type user terminal 121, the measurement/sensing result of the second-type user terminal for this first-type user terminal 111 and a predetermined value. For example, when the measurement/sensing result of the second-type user terminal for the first-type user terminal 121 is greater than the measurement/sensing result of the second-type user terminal for this first-type user terminal 111 by a predetermined value, the control unit 1111 determines that it can reselect resources for the user terminal group. Accordingly, the control unit 1111 may reselect resources for the user terminal group. In addition, if the measurement/sensing result of the second-type user terminal for the first-type user terminal 121 is not greater than the measurement/sensing result of the second-type user terminal for this first-type user terminal 111 by the predetermined value, the control unit 1111 determines not to reselect resources for the user terminal group. Accordingly, the control unit 1111 may not reselect resources for the user terminal group.

In the second embodiment of the present disclosure, the control unit 1111 may perform at least one of regrouping the user terminal group and reselecting resources for the user terminal group. When the control unit 1111 performs both of regrouping the user terminal group and reselecting resources for the user terminal group, the control unit 1111 may perform them simultaneously, or may perform the regrouping firstly and then reselect resources for the regrouped user terminal group.

With the first-type user terminal of the second embodiment of the present disclosure, when user terminal groups using the same resources or resource set move closer, a second-type user terminal in a user terminal group may detect a first-type user terminal in another user terminal group, and report a detection result to a first-type user terminal associated with itself, such that the first-type user terminal determines whether to regroup the user terminal group and/or reselect resources for the user terminal group according to the detection result, so as to ensure that a plurality of adjacent user terminal groups use resources or resource sets orthogonal to each other, thereby avoiding interference between user terminal groups, improving communication quality, and increasing a resource reuse rate.

<Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. via wire and/or wireless), and the respective functional blocks may be implemented by these apparatuses.

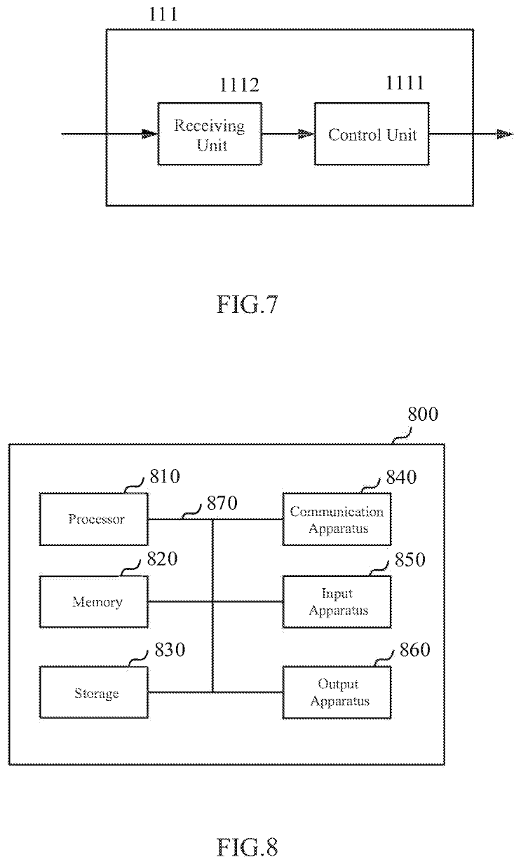

For example, a device (such as, the first communication device, the second communication device, the aerial user terminal, etc.) in an embodiment of the present disclosure may function as a computer that executes the processes of the wireless communication method of the present disclosure. FIG. 8 is a schematic diagram of a hardware structure of a device 800 involved in an embodiment of the present disclosure. The above device 800 may be constituted as a computer apparatus that physically comprises a processor 810, a memory 820, a storage 830, a communication apparatus 840, an input apparatus 850, an output apparatus 860, a bus 870 and the like

In addition, in the following description, terms such as “apparatus” may be replaced with circuits, devices, units, and the like. The hardware structure of the user terminal and the base station may include one or more of the respective apparatuses shown in the figure, or may not include a part of the apparatuses.

For example, only one processor 810 is illustrated, but there may be multiple processors. Furthermore, processes may be performed by one processor, or processes may be performed by more than one processor simultaneously, sequentially, or by other methods. In addition, the processor 810 may be installed by more than one chip.

Respective functions of any of the device 800 may be implemented, for example, by reading specified software (program) on hardware such as the processor 810 and the memory 820, so that the processor 810 performs computations, controls communication performed by the communication apparatus 840, and controls reading and/or writing of data in the memory 820 and the storage 830.

The processor 810, for example, operates an operating system to control the entire computer. The processor 810 may be constituted by a Central Processing Unit (CPU), which includes interfaces with peripheral apparatuses, a control apparatus, a computing apparatus, a register and the like. For example, the determining unit, the adjusting unit and the like described above may be implemented by the processor 810.

In addition, the processor 810 reads programs (program codes), software modules and data from the storage 830 and/or the communication apparatus 840 to the memory 820, and execute various processes according to them. As for the program, a program causing computers to execute at least a part of the operations described in the above embodiments may be employed. For example, the determining unit of the user terminal 500 may be implemented by a control program stored in the memory 820 and operated by the processor 810, and other functional blocks may also be implemented similarly.

The memory 820 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 820 may also be referred to as a register, a cache, a main memory (a main storage apparatus) and the like. The memory 820 may store executable programs (program codes), software modules and the like for implementing a method involved in an embodiment of the present disclosure.

The storage 830 is a computer-readable recording medium, and may be constituted, for example, by at least one of a flexible disk, a floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 830 may also be referred to as an auxiliary storage apparatus.

The communication apparatus 840 is a hardware (transceiver device) performing communication between computers via a wired and/or wireless network, and is also referred to as a network device, a network controller, a network card, a communication module and the like, for example. The communication device 840 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 840.

The input apparatus 850 is an input device (e.g., a keyboard, a mouse, a microphone, a switch, a button, a sensor and the like) that receives input from the outside. The output apparatus 860 is an output device (e.g., a display, a speaker, a Light Emitting Diode (LED) light and the like) that performs outputting to the outside. In addition, the input apparatus 850 and the output apparatus 860 may also be an integrated structure (e.g., a touch screen).

Furthermore, the respective apparatuses such as the processor 810 and the memory 820 are connected by the bus 870 that communicates information. The bus 870 may be constituted by a single bus or by different buses between the apparatuses.

Furthermore, the base station and the user terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 810 may be installed by at least one of these hardware.

(Variations)

In addition, the embodiments described above may be used in combination. In addition, the terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, the information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

The names used for the parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. The information, signals and the like that are output may be deleted. The information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user terminal. For example, for a structure in which communication between a wireless base station and a user terminal is replaced with communication between a plurality of user terminals (Device-to-Device, D2D), the respective manners/embodiments of the present disclosure may also be applied. At this time, functions provided by the first communication device and the second communication device of the above device 800 may be regarded as functions provided by a user terminal. Furthermore, the words “uplink” and “downlink” may also be replaced with “side”. For example, an uplink channel may be replaced with a side channel.

Also, a user terminal in this specification may be replaced with a wireless base station. At this time, functions provided by the above user terminal may be regarded as functions provided by the first communication device and the second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi), IEEE 920.16 (WiMAX), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is to say, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A first-type terminal, comprising:
a control unit configured to acquire detection information for another first-type terminal, wherein the first-type terminal is used to control a second-type terminal, and the first-type terminal and the second-type terminal belong to one terminal group;
the control unit being further configured to determine whether to regroup the terminal group at least according to the acquired detection information; and
the control unit being further configured to regroup the terminal group when it is determined to regroup the terminal group.

2. The first-type terminal of claim 1, wherein the control unit is further configured to determine whether to reselect resources for the terminal group at least according to the acquired detection information; and when it is determined to reselect resources for the terminal group, reselect resources for the terminal group.

3. The first-type terminal of claim 1, wherein the control unit is further configured to detect a discovery signal of the another first-type terminal to acquire the detection information.

4. The first-type terminal of claim 3, wherein the discovery signal is a first-type discovery signal, and the first-type discovery signal is used for the second-type terminal to detect the another first-type terminal.

5. The first-type terminal of claim 4, wherein the control unit is further configured to detect the first-type discovery signal of the another first-type terminal when muting the first-type discovery signal of the first-type terminal.

6. The first-type terminal of claim 5, wherein the control unit is further configured to determine a probability of muting the first-type discovery signal of the first-type terminal at a transmission occasion of the first-type discovery signal of the first-type terminal; and mute the first-type discovery signal of the first-type terminal at the transmission occasion according to the probability.

7. The first-type terminal of claim 6, wherein the control unit is further configured to mute the first-type discovery signal of the first-type terminal according to the probability at the transmission occasion and on specific resources of a plurality of resources corresponding to the transmission occasion.

8. The first-type terminal of claim 5, wherein the control unit is further configured to determine a muting pattern for a transmission occasion of the first-type discovery signal of the first-type terminal; and mute the first-type discovery signal of the first-type terminal at the transmission occasion according to the muting pattern.

9. The first-type terminal of claim 8, wherein the control unit is further configured to determine, according to the muting pattern, whether to mute the first-type discovery signal of the first-type terminal on each of a plurality of resources corresponding to the transmission occasion; and muting the first-type discovery signal of the first-type terminal according to a determination result.

10. The first-type terminal of claim 8, wherein the control unit is further configured to periodically determine the muting pattern for the transmission occasion of the first-type discovery signal of the first-type terminal.

11. The first-type terminal of claim 8, wherein the control unit is further configured to trigger the first-type terminal to re-determine a muting pattern for the transmission occasion of the first-type discovery signal of the first-type terminal by a specific event.

12. The first-type terminal of claim 3, wherein the discovery signal is a second-type discovery signal, and the second-type discovery signal is used for the first-type terminal to detect the another first-type terminal.

13. The first-type terminal of claim 3, wherein the control unit is further configured to detect a dedicated signal of the another first-type terminal, and wherein the dedicated signal includes at least information carried by the discovery signal of the another first-type terminal.

14. The first-type terminal of claim 1, wherein the control unit is further configured to receive the detection information from the second-type terminal, and wherein the detection information is acquired by the second-type terminal detecting the discovery signal of the another first-type terminal.

15. The first-type terminal of claim 14, wherein the detection information is measurement information acquired by the second-type terminal detecting the discovery signal of the another first-type terminal and measuring the another first-type terminal according to the discovery signal of the another first-type terminal.

16. The first-type terminal of claim 15, further comprising:
a receiving unit configured to receive, from the second-type terminal, the measurement information of the second-type terminal for the first-type terminal;
wherein the control unit is further configured to determine whether to regroup the terminal group according to the acquired detection information and the measurement information of the second-type terminal for the first-type terminal.

17. A method performed by a first-type terminal, the method comprising:
acquiring detection information for another first-type terminal, wherein the first-type terminal is used to control a second-type terminal, and the first-type terminal and the second-type terminal belong to one terminal group;
determining whether to regroup the terminal group at least according to the acquired detection information; and
regrouping the terminal group when it is determined to regroup the terminal group.

18. The method of claim 17, further comprising:
determining whether to reselect resources for the terminal group at least according to the acquired detection information; and
reselecting resources for the terminal group when it is determined to reselect resources for the terminal group.
